(19) United States
(12) Patent Application Publication
(10) Pub. No.: US 2026/0045012 A1
(43) Pub. Date: Feb. 12, 2026

(54) IMAGE EDITING WITH GENERATIVE ARTIFICIAL INTELLIGENCE

(71) Applicant: Google LLC, Mountain View, CA (US)

(72) Inventors: Jingyu WU, Mountain View, CA (US); Tuo WANG, Mountain View, CA (US); Jessi TSAI, Mountain View, CA (US); Tim HAYWOOD, Mountain View, CA (US); Michelle CHEN, Mountain View, CA (US); Chorong JOHNSTON, Mountain View, CA (US); Daniel STEINBOCK, Mountain View, CA (US); Jose Ricardo LIMA, Mountain View, CA (US); Chuanlong XIA, Mountain View, CA (US); Derin BABACAN, Mountain View, CA (US); Daniel Hung-yu WU, Mountain View, CA (US); Timothy KNIGHT, Mountain View, CA (US); Chia-Kai LIANG, Mountain View, CA (US); Alex Rav ACHA, Mountain View, CA (US); Yaron BRODSKY, Mountain View, CA (US); Qinghao CHU, Mountain View, CA (US); Shlomo FRUCHTER, Mountain View, CA (US); Yael Pritch KNAAN, Mountain View, CA (US); Matan COHEN, Mountain View, CA (US); Andrey VOYNOV, Mountain View, CA (US); Bryan FELDMAN, Mountain View, CA (US); Tamas PATAKY, Mountain View, CA (US); Meeran ISMAIL, Mountain View, CA (US)

(73) Assignee: Google LLC, Mountain View, CA (US)

(21) Appl. No.: 19/297,713

(22) Filed: Aug. 12, 2025

Related U.S. Application Data
(60) Provisional application No. 63/682,225, filed on Aug. 12, 2024.
(60) Provisional application No. 63/682,231, filed on Aug. 12, 2024.

(51) Int. Cl. G06T 11/60; G06F 3/04817; G06T 5/60; G06T 7/194; G06T 13/80

(52) U.S. Cl. CPC G06T 11/60; G06F 3/04817; G06T 5/60; G06T 7/194; G06T 13/80; G06T 2200/24

(57) ABSTRACT

A computer-implemented method includes receiving a request for a type of output image and a prompt from a user that describes an output image. The method further includes selecting, based on the type of output image and the prompt, a machine-learning model from a set of machine-learning models. The method further includes providing the request and the prompt as input to the selected machine-learning model. The method further includes generating, by the selected machine-learning model, the output image that satisfies the request and the prompt.

### CROSS-REFERENCE TO RELATED APPLICATIONS

This application is a non-provisional application that claims priority under 35 U.S.C. § 119 (e) to U.S. Provisional Patent Application No. 63/682,225, filed on Aug. 12, 2024 and entitled “Applications of Generative Artificial Intelligence,” and U.S. Provisional Patent Application No. 63/682,231, filed on Aug. 12, 2024 and entitled “Selection of Machine-Learning Model for Image Editing.” U.S. Provisional Patent Application No. 63/682,225 and U.S. Provisional Patent Application No. 63/682,231 are both incorporated by reference herein by their entirety.

### BACKGROUND

Generative artificial intelligence (AI) may be used to generate images from text prompts. A user may visit a website or use a software tool with generative AI capabilities that outputs an image, but the image has limited application. Furthermore, the results are often unrealistic.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A computer-implemented method includes receiving a request for a type of output image and a prompt from a user that describes an output image. The method further includes selecting, based on the type of output image and the prompt, a machine-learning model from a set of machine-learning models. The method further includes providing the request and the prompt as input to the selected machine-learning model. The method further includes generating, by the selected machine-learning model, the output image that satisfies the request and the prompt.

In some embodiments, the method further includes generating a rewritten prompt based on the request for the type of output image and the prompt, where selecting the machine-learning model based on the type of output image and the prompt is further based on the rewritten prompt. In some embodiments, the type of output image includes a sticker, the selected machine-learning model is trained to output the sticker, and the output image is the sticker. In some embodiments, the method further includes receiving a subsequent prompt that describes an action to be performed as an animation by the sticker and generating, by the selected machine-learning model, the animation based on the subsequent prompt. In some embodiments, the method further includes receiving user input that selects one or more objects from the output image and a subsequent request to generate a sticker from the output image, segmenting the one or more selected objects from a background, and generating the sticker, wherein the sticker includes a transparent version of the background. In some embodiments, the request for the type of output image is a request to generate a sticker, the method further comprises receiving an initial image, and generating, by the selected machine-learning model, the output image that satisfies the request and the prompt includes generating the sticker based on the initial image, the prompt, and the request to generate the sticker.

In some embodiments, the method further includes receiving an initial image of the user and a request to generate an avatar, where generating, by the selected machine-learning model, the output image that satisfies the prompt includes generating the avatar based on the initial image, the prompt, and the request to generate the avatar. In some embodiments, generating a user interface that includes a text field and an option to add a name of the avatar to the text field and an option to add the avatar to a text chat by writing the name of the avatar in the text chat. In some embodiments, receiving a subsequent prompt that includes a request to generate a subsequent output image that includes the avatar performing an action and generating, with the selected machine-learning model, the subsequent output image that satisfies the subsequent prompt by illustrating the avatar performing the action. In some embodiments, the method further includes providing the avatar to a messaging application associated with the user; receiving a subsequent prompt from the messaging application associated with the user that includes a request to generate a video that includes the avatar performing an action; generating, with the selected machine-learning model, an output video that satisfies the request to generate the video that includes the avatar performing the action; and providing the output video to the messaging application. In some embodiments, receiving a subsequent prompt that includes a request to generate a subsequent output image of the avatar in one or more pieces of clothing and generating, with the selected machine-learning model, the subsequent output image that satisfies the subsequent prompt by illustrating the avatar in the one or more pieces of clothing. In some embodiments, the method further includes providing a user interface to the user that includes an icon of the avatar and a text field, receiving a selection of the icon of the avatar, displaying the icon of the avatar in the text field, receiving a subsequent prompt via the text field, and generating a subsequent output image that satisfies the subsequent prompt and that includes the avatar based on the text field including the icon of the avatar in the text field.

In some embodiments, the method further includes providing subsequent prompts as inputs to the selected machine-learning model one or more times as the user provides subsequent inputs refining the prompt, wherein the subsequent inputs include one or more new words, replacement of words of the prompt, or combinations thereof and outputting subsequent output images responsive to receiving the subsequent prompts. In some embodiments, the set of machine learning models includes a plurality of different machine-leaning models. In some embodiments, the set of machine-learning models includes a structure-preserving machine-learning model, a shape-preserving machine-learning model, and a non-structure and non-shape preserving machine-learning model.

A system comprises one or more processors and one or more computer-readable media coupled to the one or more processors, having instructions stored thereon that, when executed by the one or more processors, cause the one or more processors to perform or control performance of operations. The operations include receiving a request for a type of output image and a prompt from a user that describes an output image; selecting, based on the type of output image and the prompt, a machine-learning model from a set of machine-learning models; providing the request and the prompt as input to the selected machine-learning model; and generating, by the selected machine-learning model, the output image that satisfies the request and the prompt.

In some embodiments, the operations further include generating a rewritten prompt based on the request for the type of output image and the prompt, where selecting the machine-learning model based on the type of output image and the prompt is further based on the rewritten prompt. In some embodiments, the type of output image includes a sticker, the selected machine-learning model is trained to output the sticker, and the output image is the sticker.

A non-transitory computer-readable medium with instructions stored thereon that, when executed by one or more computers, cause the one or more computers to perform or control performance of operations. The operations include receiving a request for a type of output image and a prompt from a user that describes an output image; selecting, based on the type of output image and the prompt, a machine-learning model from a set of machine-learning models; providing the request and the prompt as input to the selected machine-learning model; and generating, by the selected machine-learning model, the output image that satisfies the request and the prompt.

In some embodiments, the operations further include generating a rewritten prompt based on the request for the type of output image and the prompt, where selecting the machine-learning model based on the type of output image and the prompt is further based on the rewritten prompt. In some embodiments, the type of output image includes a sticker, the selected machine-learning model is trained to output the sticker, and the output image is the sticker.

### BRIEF DESCRIPTION OF THE DRAWINGS

FIG. 1 is a block diagram of an example network environment, according to some embodiments described herein.

FIG. 2 is a block diagram of an example computing device, according to some embodiments described herein.

FIGS. 3A-3C illustrate example user interfaces of different ways to begin using the media application, according to some embodiments described herein.

FIGS. 4A-4C illustrate example user interfaces with sample images that were generated by the media application, according to some embodiments described herein.

FIGS. 5A-5H illustrate example user interfaces for generating an output image that updates while a user adds text to the prompt, according to some embodiments described herein.

FIG. 6 illustrates example layers for an output image, according to some embodiments described herein.

FIGS. 7A-7F illustrate example user interfaces for generating an output image from text, requesting a subsequent output image, requesting a subsequent output image in a different style, and generating a sticker from the output image, according to some embodiments described herein.

FIGS. 8A-8C illustrate example configurations of an introductory user interface based on different configurations of a foldable user device, according to some embodiments described herein.

FIGS. 9A-9C illustrate example user interfaces with example output images for different categories, according to some embodiments described herein.

FIGS. 10A-10C illustrate example user interfaces for generating a sticker from text, according to some embodiments described herein.

FIGS. 11A-11E illustrate example user interfaces for generating an avatar, according to some embodiments described herein.

FIGS. 12A-12G illustrate example user interfaces for requesting that an avatar be added to an output image, according to some embodiments described herein.

FIGS. 13A-13J illustrate example user interfaces for generating output images of an avatar for a group text, according to some embodiments described herein.

FIGS. 14A-14D illustrate example user interfaces for generating a personalized birthday card that is associated with a calendar event, according to some embodiments described herein.

FIGS. 15A-15C illustrate example web pages and user interface for generating an output image of a user wearing clothing, according to some embodiments described herein.

FIGS. 16A-16D illustrate example user interfaces for generating an output image from a sketch, according to some embodiments described herein.

FIGS. 17A-17C illustrate example user interfaces for using a conversational style to edit an initial image, according to some embodiments described herein.

FIGS. 18A-18D illustrate example user interfaces for using a conversational style for generating an output image of a room, according to some embodiments described herein.

FIGS. 19A-19G illustrate example user interfaces for using a conversational style for editing screenshots, according to some embodiments described herein.

FIGS. 20A-20G illustrate example user interfaces that support gesture editing, according to some embodiments described herein.

FIG. 21A-21C illustrates an architecture of an example diffusion model, according to some embodiments described herein.

FIG. 22 illustrates a flowchart of a method to generate an output image, according to some embodiments described herein.

### DETAILED DESCRIPTION

### Overview

Digital media has become an integral part of modern communication, with users frequently capturing, editing, and sharing images and videos on their personal devices. The advent of sophisticated editing tools on these devices has empowered users to modify their digital content in various ways. For instance, users can perform basic edits such as cropping and rotating images, as well as more advanced operations like removing unwanted objects from a photograph or replacing the background of an image.

More recently, machine-learning models, particularly generative artificial intelligence (AI) models, have enabled new forms of content creation and modification. Text-to-image models allow users to generate novel images from textual descriptions. Similarly, image-to-image models can take an initial image and a text prompt as input to produce a modified output image that incorporates the user's request. For example, a user can provide a photo of their dog and a prompt like “make the dog wear a superhero cape” to generate a new image.

However, existing systems for generative image creation and editing present several challenges. The user experience can be fragmented, often requiring users to switch between different applications or tools to accomplish a series of edits. For instance, the underlying machine-learning models are often highly specialized. A model that excels at photorealistic image generation may perform poorly on stylistic or cartoonish creations, and vice-versa. Users typically have no control over which model is used for their specific request, which can lead to suboptimal or inconsistent results. This lack of an integrated, intelligent system that can select the appropriate model based on the user's intent and provide a seamless workflow for creating, editing, and personalizing digital content limits the creative potential and overall user experience. In addition, using these traditional generative image creation models is computationally expensive because a user may have to repeatedly request the traditional generative image creation model to keep generating new images several (possibly dozens) of times until the user is satisfied with the result.

The technology described herein advantageously addresses these issues by selecting a machine-learning model from a set of machine-learning models based on the text prompt. For example, if a user wants to create a photorealistic avatar from an initial image of the user, the selected machine-learning model may be an image-to-image machine-learning model that was trained to use a depth map. In another example, if a user wants to create a cartoon sticker from only the text prompt and not from an initial image, the selected machine-learning model may be a text-to-image machine-learning model that was trained to generate cartoon images. The selection of a machine-learning model can include analyzing the text prompt and selecting a specific machine-learning model by linking the analysis result to capabilities of the specific machine-learning model from the set of machine-learning models. By selecting a machine-learning model from a set of specialized models, the system avoids invoking a large, general-purpose model for all tasks. This selection provides the technical effect of allocating computational resources more efficiently, as a smaller, specialized model (e.g., one trained only for sticker generation) requires fewer processing cycles and less memory than a large, all-purpose model. This leads to reduced power consumption on the user device and lower latency for the end-user.

The technology also describes numerous applications for generative AI. The selected machine-learning model may generate an avatar of a user and receive a text prompt to include the avatar in an image. For example, the text prompt may include a request for an output image that includes the avatar of the user and an avatar of the user's grandmother that can be used as an invitation to the grandmother's birthday party.

The technology may also be seamlessly integrated with other applications. Continuing with the previous example, a media application that was used to generate the output image may provide the output image to a messaging application. The user may access the invitation to the grandmother's birthday party in the messaging application, such as by accessing a folder on the messaging application, calling the media application from within the messaging application, etc. In another example, the selected machine-learning model generates output images that are personalized with avatars of family members that can be added to a group chat. In yet another example, a user may discuss different design ideas for changing their home in a messaging application where the messaging application transmits a command to the media application and receives an output image that satisfies a prompt provided by the user.

In some embodiments, a shopping application may have access to the avatar and use the shopping application in conjunction with the media application to model clothing. The selected machine-learning model may generate an output image that combines an image of a sweater with the user so that the user can see what the user would look like in the sweater. In yet another example, the selected machine-learning model generates output images that modify details of an initial image of a room to help the user make decorating choices.

Various embodiments include image generation (new images from a text prompt), image editing (modifying a user-initial image in response to a text prompt) including object deletion or replacement (e.g., deleting one or more objects in the initial image, replacing one object with another, etc.), object repositioning and/or resizing (e.g., moving the object from one part of the image to another, changing the size of the object, etc.), image relighting or recoloring (e.g., vibrancy, color shades, etc.), generating a photographic or rich color image from a sketch, applying artistic effects, etc., and combinations thereof.

### Network Environment

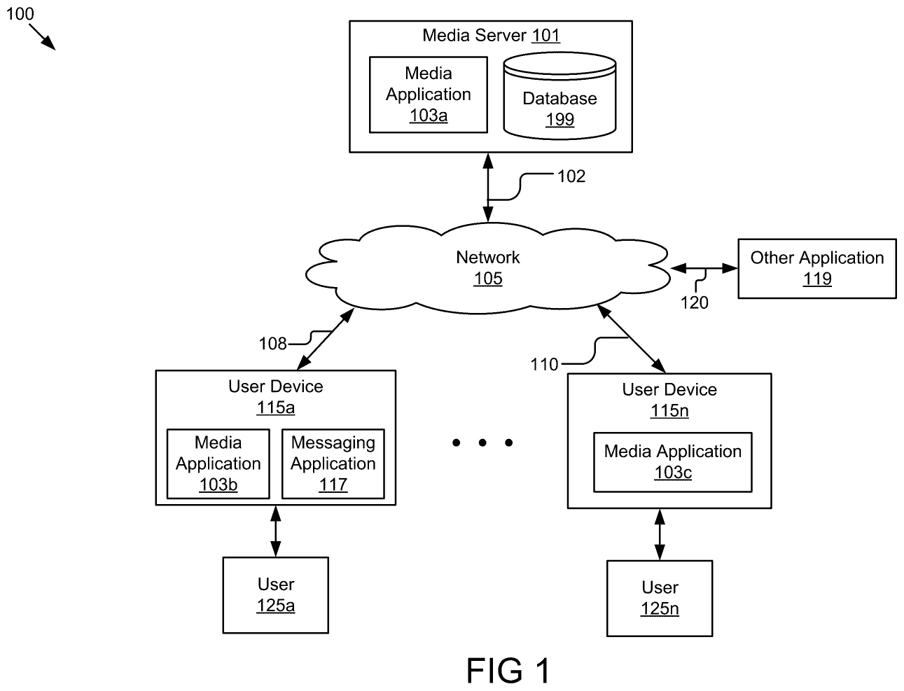

FIG. 1 illustrates a block diagram of an example environment 100. In some embodiments, the environment 100 includes a media server 101, user devices 115a . . . 115n, and another application 119 coupled to a network 105. Users 125a, 125n may be associated with respective user devices 115a, 115n. In some embodiments, the environment 100 may include other servers or devices not shown in FIG. 1. In FIG. 1 and the remaining figures, a letter after a reference number (e.g., “115a”) represents a reference to the element having that particular reference number. A reference number in the text without a following letter (e.g., “115”) represents a general reference to embodiments of the element bearing that reference number.

The media server 101 may include a processor, a memory, and network communication hardware. In some embodiments, the media server 101 is a hardware server. The media server 101 is communicatively coupled to the network 105 via signal line 102. Signal line 102 may be a wired connection, such as Ethernet, coaxial cable, fiber-optic cable, etc., or a wireless connection, such as Wi-Fi®, Bluetooth®, or other wireless technology. In some embodiments, the media server 101 sends and receives data to and from one or more of the user devices 115a, 115n via the network 105. The media server 101 may include a media application 103a and a database 199.

The database 199 may store machine-learning models, training data sets, images, etc. The database 199 may also store social network data associated with users 125, user preferences for the users 125, etc.

The user device 115 may be a computing device that includes a memory coupled to a hardware processor. For example, the user device 115 may include a mobile device, a tablet computer, a mobile telephone, a wearable device, a head-mounted display, a mobile email device, a portable game player, a portable music player, a reader device, or another electronic device capable of accessing a network 105.

In the illustrated implementation, user device 115a is coupled to the network 105 via signal line 108 and user device 115n is coupled to the network 105 via signal line 110. The media application 103 may be stored as media application 103b on the user device 115a and/or media application 103c on the user device 115n. Signal lines 108 and 110 may be wired connections, such as Ethernet, coaxial cable, fiber-optic cable, etc., or wireless connections, such as Wi-Fi®, Bluetooth®, or other wireless technology. User devices 115a, 115n are accessed by users 125a, 125n, respectively. The user devices 115a, 115n in FIG. 1 are used by way of example. While FIG. 1 illustrates two user devices, 115a and 115n, the disclosure applies to a system architecture having one or more user devices 115.

The media application 103 may be stored on the media server 101 or the user device 115. In some embodiments, the operations described herein are performed on the media server 101 or the user device 115. For example, a media application 103b on the user device 115a may receive an initial image captured by the user device 115a and generate an output image. In some embodiments, some operations may be performed on the media server 101 and some may be performed on the user device 115. For example, an initial image may be captured by the user device 115a and transmitted with user input and a text prompt to the media application 103a on the media server 101, which generates an output image that is transmitted to the media application 103b on the user device 115a for display.

Performance of operations is in accordance with user settings. For example, the user 125a may specify settings that operations are to be performed on their respective device 115a and not on the media server 101. With such settings, operations described herein are performed entirely on user device 115a and no operations are performed on the media server 101. Further, a user 125a may specify that images and/or other data of the user is to be stored only locally on a user device 115a and not on the media server 101. With such settings, no user data is transmitted to or stored on the media server 101. Transmission of user data to the media server 101, any temporary or permanent storage of such data by the media server 101, and performance of operations on such data by the media server 101 are performed only if the user has agreed to transmission, storage, and performance of operations by the media server 101. Users are provided with options to change the settings at any time (e.g., such that they can enable or disable the use of the media server 101).

Machine learning models (e.g., diffusion models or other types of models), if utilized for one or more operations, are stored and utilized locally on a user device 115, with specific user permission. Server-side models are used only if permitted by the user. Further, a trained model may be provided for use on a user device 115. During such use, if permitted by the user 125, on-device training of the model may be performed. In some embodiments, on-device training includes using fewer parameters than are used on the server-side model in order to improve the computational efficiency of the on-device model. Updated model parameters may be transmitted to the media server 101 if permitted by the user 125 (e.g., to enable federated learning. Model parameters do not include any user data).

In some embodiments, the media application 103 receives an initial image and a text prompt from a user where the text prompt includes a request to modify the initial image. The media application 103 selects, based on the text prompt, a machine-learning model from a set of machine-learning models. The media application 103 provides the initial image and the text prompt as input to the selected machine-learning model. The selected machine-learning model generates an output image that satisfies the text prompt.

In some embodiments, the output image may be used by other applications that are part of a user device 115. For example, user device 115a includes a messaging application 117. The messaging application 117 receives the output image from the media application 103b. For example, the media application 103b may automatically make any output images accessible to the messaging application 117. In another example, the messaging application 117 may request an output image from the media application 103b (e.g., when a user provides a text prompt for the media application 103b from a user interface provided by the messaging application 117).

In some embodiments, the output image may be used by other applications that are not part of the user device 115. For example, the other application 119 may include a processor, a memory, and network communication hardware. The other application 119 may be a third-party application that is not affiliated with the media application 103 or the other application 119 may be owned by the same company as the media application 103. The other application 119 may receive output images from the media application 103. For example, the other application 119 may be a shopping application that receives an avatar associated with a user 125a from the media application 103b stored on the user device 115a. The user 125a may select items of clothing within the shopping application and request that the selected items be modeled on the avatar.

The media application 103 may be implemented using hardware including a central processing unit (CPU), a field-programmable gate array (FPGA), an application-specific integrated circuit (ASIC), machine learning processor/co-processor, any other type of processor, or a combination thereof. In some embodiments, the media application 103a may be implemented using a combination of hardware and software.

### Computing Device

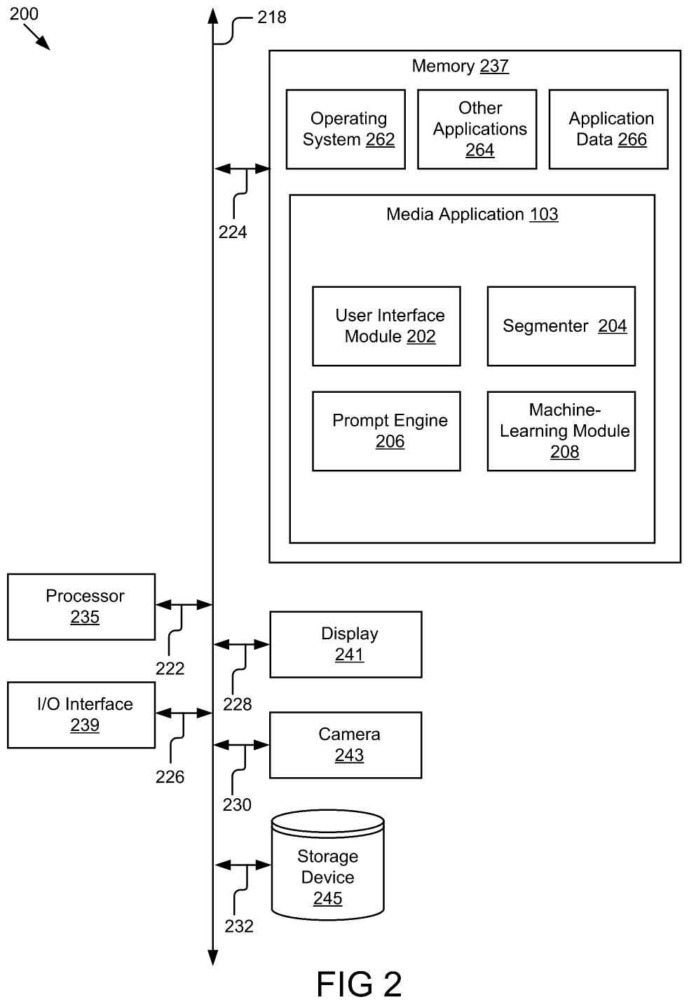

FIG. 2 is a block diagram of an example computing device 200 that may be used to implement one or more features described herein. Computing device 200 can be any suitable computer system, server, or other electronic or hardware device. In one example, computing device 200 is media server 101 used to implement the media application 103a. In another example, computing device 200 is a user device 115.

In some embodiments, computing device 200 includes a processor 235, a memory 237, an input/output (I/O) interface 239, a display 241, a camera 243, and a storage device 245 all coupled via a bus 218. The processor 235 may be coupled to the bus 218 via signal line 222, the memory 237 may be coupled to the bus 218 via signal line 224, the I/O interface 239 may be coupled to the bus 218 via signal line 226, the display 241 may be coupled to the bus 218 via signal line 228, the camera 243 may be coupled to the bus 218 via signal line 230, and the storage device 245 may be coupled to the bus 218 via signal line 232.

Processor 235 can be one or more processors and/or processing circuits to execute program code and control basic operations of the computing device 200. A “processor” includes any suitable hardware system, mechanism or component that processes data, signals or other information. A processor may include a system with a general-purpose central processing unit (CPU) with one or more cores (e.g., in a single-core, dual-core, or multi-core configuration), multiple processing units (e.g., in a multiprocessor configuration), a graphics processing unit (GPU), a field-programmable gate array (FPGA), an application-specific integrated circuit (ASIC), a complex programmable logic device (CPLD), dedicated circuitry for achieving functionality, a special-purpose processor to implement neural network model-based processing, neural circuits, processors optimized for matrix computations (e.g., matrix multiplication), or other systems. In some embodiments, processor 235 may include one or more co-processors that implement neural-network processing. In some embodiments, processor 235 may be a processor that processes data to produce probabilistic output (e.g., the output produced by processor 235 may be imprecise or may be accurate within a range from an expected output). Processing need not be limited to a particular geographic location or have temporal limitations. For example, a processor may perform its functions in real-time, offline, in a batch mode, etc. Portions of processing may be performed at different times and at different locations, by different (or the same) processing systems. A computer may be any processor in communication with a memory.

Memory 237 is typically provided in computing device 200 for access by the processor 235, and may be any suitable processor-readable storage medium, such as random access memory (RAM), read-only memory (ROM), Electrical Erasable Read-only Memory (EEPROM), Flash memory, etc., suitable for storing instructions for execution by the processor or sets of processors, and located separate from processor 235 and/or integrated therewith. Memory 237 can store software operating on the computing device 200 by the processor 235, including a media application 103.

The memory 237 may include an operating system 262, other applications 264, and application data 266. Other applications 264 can include, e.g., an image library application, an image management application, an image gallery application, communication applications, web hosting engines or applications, media sharing applications, etc. One or more methods disclosed herein can operate in several environments and platforms, e.g., as a stand-alone computer program that can run on any type of computing device, as a web application having web pages, as a mobile application (“app”) run on a mobile computing device, etc.

The application data 266 may be data generated by the other applications 264 or hardware of the computing device 200. For example, the application data 266 may include images used by the image library application and user actions identified by the other applications 264 (e.g., a social networking application, etc.).

I/O interface 239 can provide functions to enable interfacing the computing device 200 with other systems and devices. Interfaced devices can be included as part of the computing device 200 or can be separate and communicate with the computing device 200. For example, network communication devices, storage devices (e.g., memory 237 and/or storage device 245), and input/output devices can communicate via I/O interface 239. In some embodiments, the I/O interface 239 can connect to interface devices such as input devices (keyboard, pointing device, touchscreen, microphone, scanner, sensors, etc.) and/or output devices (display devices, speaker devices, printers, monitors, etc.).

Some examples of interfaced devices that can connect to I/O interface 239 can include a display 241 that can be used to display content, e.g., images, video, and/or a user interface of an output application as described herein, and to receive touch (or gesture) input from a user. For example, display 241 may be utilized to display a user interface that includes a graphical guide on a viewfinder. Display 241 can include any suitable display device such as a liquid crystal display (LCD), light emitting diode (LED), or plasma display screen, cathode ray tube (CRT), television, monitor, touchscreen, three-dimensional display screen, or other visual display device. For example, display 241 can be a flat display screen provided on a mobile device, multiple display screens embedded in a glasses form factor or headset device, or a monitor screen for a computer device.

Camera 243 may be any type of image capture device that can capture images and/or video. In some embodiments, the camera 243 captures images or video that the I/O interface 239 transmits to the media application 103.

The storage device 245 stores data related to the media application 103. For example, the storage device 245 may store a training data set that includes labeled images, a machine-learning model, output from the machine-learning model, etc.

FIG. 2 illustrates an example media application 103, stored in memory 237, that includes a user interface module 202, a segmenter 204, a prompt engine 206, and a machine-learning module 208. The user interface module 202, segmenter 204, prompt engine 206, and machine-learning module 208 may be implemented as code or other computer-readable instructions that are executable by one or more processors, such as the processor 235.

The user interface module 202 generates graphical data for displaying a user interface that includes images. Various examples of user interfaces that may be generated by the user interface module 202 are described below. In some embodiments, the user interface module 202 displays a text field where the user provides a text prompt that is used by a selected machine-learning model (e.g., a text-to-image machine-learning model, a text-to-image machine-learning model that is trained to output photorealistic images, an image-to-image machine-learning model, an image-to-image machine-learning model that is trained to output a particular style of image, etc.) to generate an output image based on the text prompt.

The user interface module 202 generates graphical data for displaying an output image. In some embodiments, the user interface module 202 includes options for enabling multiple edits to an initial image. For example, a user may provide a first text prompt and receive a first output image, the user may provide a second text prompt and receive a second output image, etc. until the user is satisfied with the results. The user interface may also include options for sharing the output image, adding the output image to a photo album, adding a title to the output image, etc.

In some embodiments, a user interface module 202 generates a user interface that includes options for generating an output image that is a sticker. An example of a sticker is an image of a single object (or one or more objects that are closely related, such as two people hugging each other) that may be overlaid or otherwise applied to other images. The output image may be a sticker alone or a sticker with additional features, such as a sticker with words added, an animation, etc. The sticker may be demarcated by a while line that surrounds the object (or objects) in the sticker. In some embodiments, a user may describe all the attributes of the sticker or the user interface module 202 may generate presets associated with the sticker.

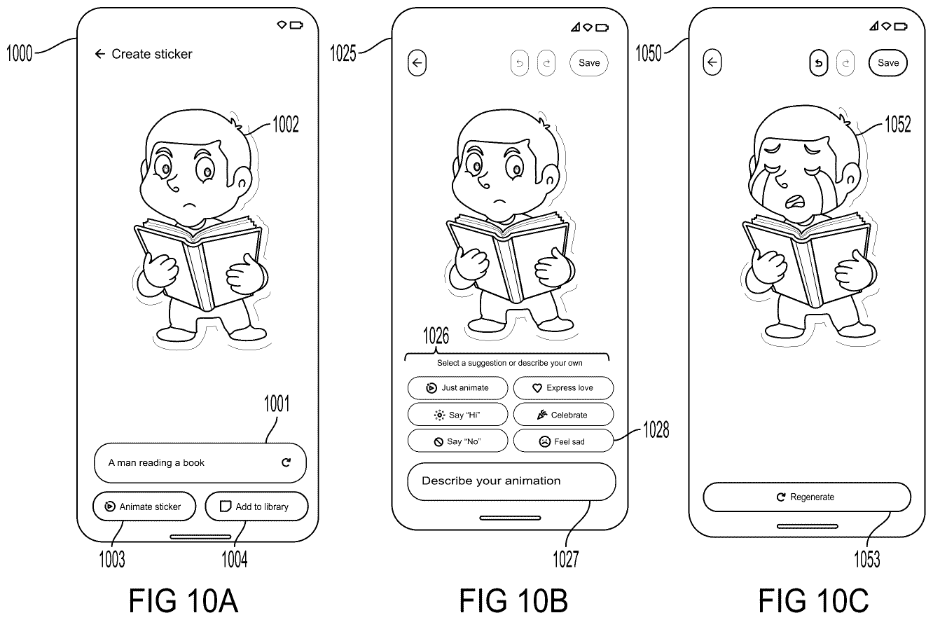

FIGS. 10A-10C respectively illustrate example user interfaces 1000, 1025, 1050 for generating a sticker from text, according to some embodiments described herein.

### Text-to-Image User Interfaces

In some embodiments, the user interface module 202 generates presets that are displayed with a user interface. The presets may include different types of categories or styles that a selected machine-learning model uses to determine an output image. For example, the presets may include a purpose of the output image (e.g., an invitation to a party, inspiration for decorating a home, a whimsical image to share with friends, etc.). In some embodiments, the presets may include a type of output image (e.g., a sticker, a video, an animation, etc.). The user interface module 202 generates a preset as a selectable icon that, when selected, causes an output image to be generated that satisfies the description in the preset. In some embodiments, the user interface module 202 provides the same set of presets in response to a user selecting an edit button and/or a suggestions button.

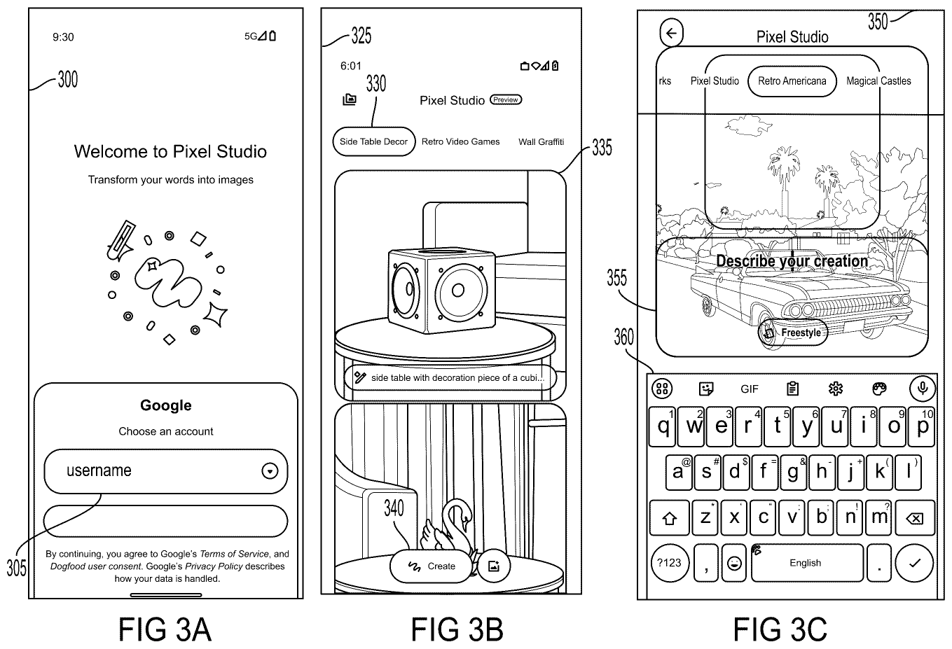

FIGS. 3A-3C respectively illustrate example user interfaces 300, 325, 350 of different ways to begin using the media application 103, according to some embodiments described herein. FIG. 3A illustrates a user interface 300 that includes a welcome screen and an option to sign into the media application 103 by providing a username 305.

FIG. 3B illustrates a user interface 325 that includes examples of suggestions for output images. For example, the option 330 “side table decor” is illustrated as an output image 335. The user interface 325 includes an option for a user to select a “create” button 340 to request that the media application 103 generate an output image.

Responsive to a user selecting the “create” button 340 in FIG. 3B, FIG. 3C illustrates a user interface 350 with a text field 355 where a user may enter a text prompt that is used by the media application 103 to generate an output image. Selecting the text field 355 may cause a virtual keyboard 360 to be displayed by the graphical user interface module 202.

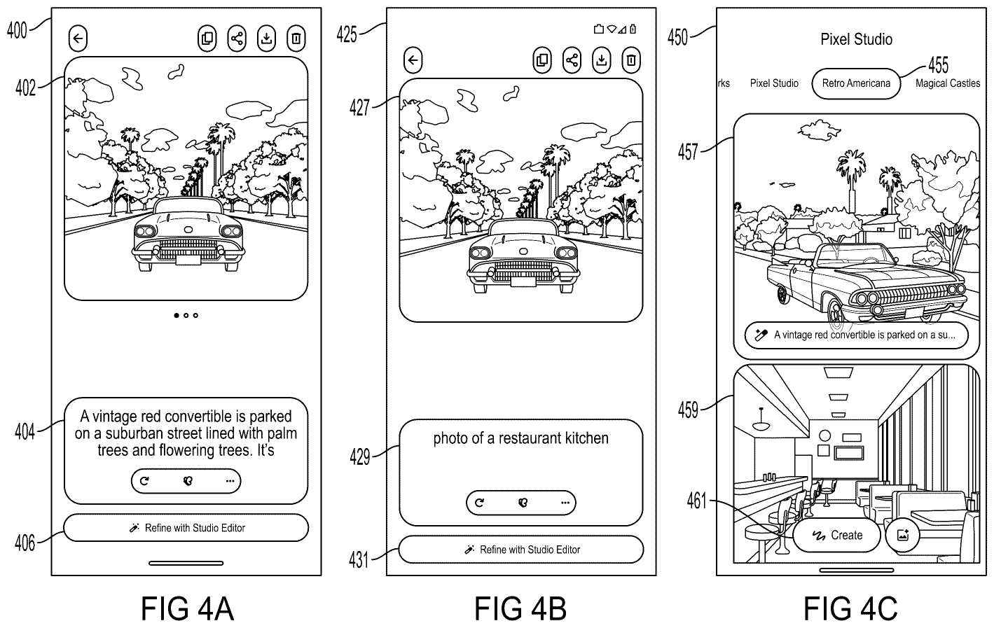

FIGS. 4A-4C respectively illustrate example user interfaces 400, 425, 450 with sample images that were generated by the media application 103, according to some embodiments described herein. FIG. 4A illustrates a user interface 400 where a user provided a text prompt in the text field 404 and a selected machine-learning model generated the output image 402. In this example, the user requested “a vintage red convertible is parked on a suburban street lined with palm trees and flowering trees. It's . . . ” The user may provide additional context and select the “refine with studio editor” button 406 to instruct the selected machine-learning model to generate a subsequent output image.

FIG. 4B includes a user interface 425 with an output image 427 and a text field 429 where a user entered a text prompt for a different output image. Specifically, the user requested “photo of a restaurant kitchen” in the text field 429. The user interface 425 also includes a “refine with studio editor” button 431 that can be used to modify the output image 427. Responsive to a user selecting the “refine with studio editor” button 431 in FIG. 4B, the selected machine-learning model generates the output image 427.

FIG. 4C illustrates a user interface 450 that includes different styles of output images. For example, the “retro Americana” style 455 is selected and examples of previously generated output images 457 and 459 are illustrated. The user interface 450 includes an option for a user to select a “create” button 461 to request that a selected machine-learning model generate an additional output image.

In some embodiments, a user requests that an output image be regenerated to reflect a different style. As discussed in greater detail below, the prompt engine 206 may select a different machine-learning model from the set of machine-learning models to generate a new output image in the different style. For example, if a first style is the “retro Americana” style 455 illustrated in FIG. 4C, a second style may be a photorealistic style that is trained on different aspects (e.g., trained using a depth map). In some embodiments, the selected machine-learning model that is used to generate the “retro Americana” style is trained using training data that includes Americana images.

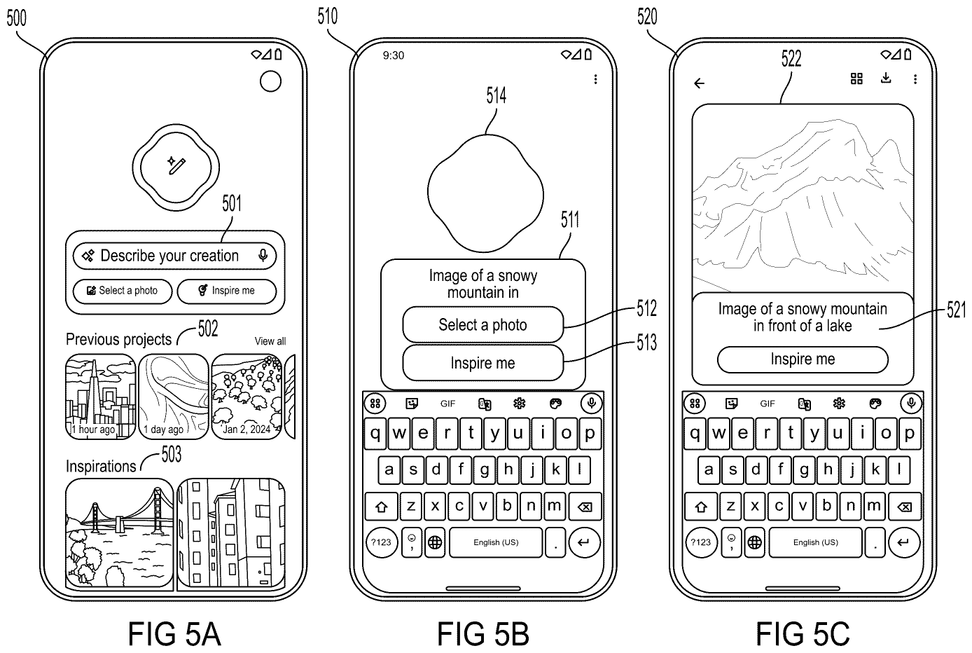

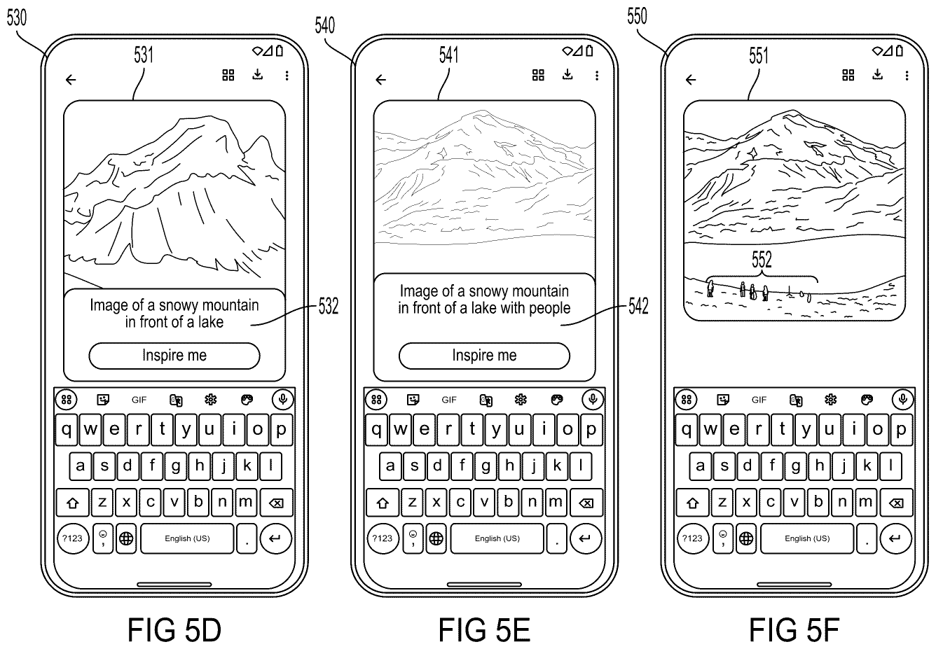

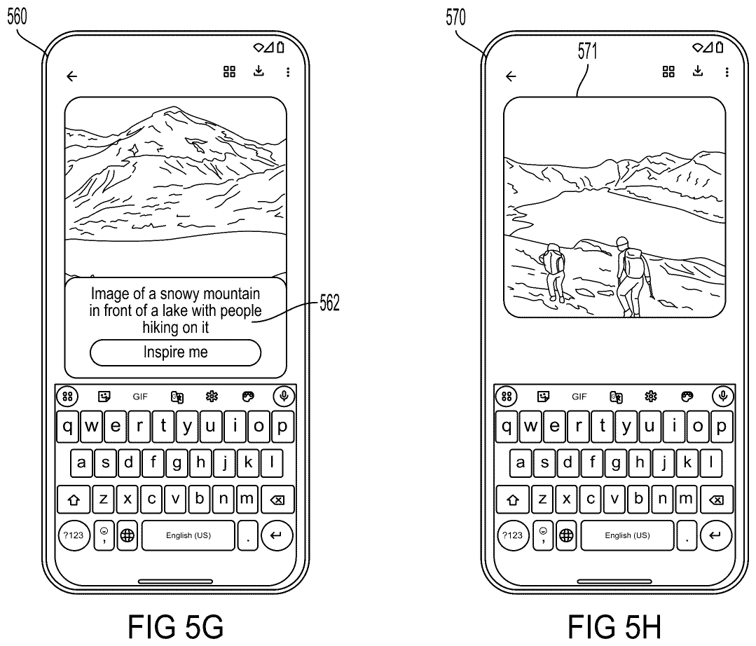

FIGS. 5A-5H respectively illustrate example user interfaces 500, 510, 520, 530, 540, 550, 560, 570 for generating an output image that updates while a user adds text to the prompt, according to some embodiments described herein.

FIG. 5A illustrates an example user interface 500 that includes a text field 501 where a user can provide a text prompt and also includes images of previous output images (labelled “previous projects” 502) that were generated using a selected machine-learning model. The user interface 500 also includes inspirations 503 that include illustrative images previously generated by one or more machine-learning models in the set of machine-learning models. The inspirations 503 highlight the media application's 103 image generation capabilities.

FIG. 5B illustrates an example user interface 510 where a user has begun to provide a text prompt in the text field 511. The user interface 500 includes an icon 514 to indicate that an output image is being generated. The user may press the “select a photo” button 512 to provide an initial image that is used along with the text prompt by a selected machine-learning model to generate an output image using an image-to-image machine-learning model. Alternatively, the user may press the “inspire me” button 513 to generate the output image. As a result of selecting the “inspire me” button 513, the selected machine-learning model is a text-to-image machine-learning model.

In some embodiments, the selected machine-learning model generates output images while a user is typing. For example, FIG. 5C illustrates an example user interface 520 that includes the text prompt from FIG. 5B of “Image of a snowy mountain in” where the user selected the “inspire me” button 513. As the user continues to type the text prompt in the text field 521 illustrated in FIG. 5C (i.e., “Image of a snowy mountain in front of a lake”), the initial generated image is surfaced with a color overlay 522 (that may match the icon 514 in FIG. 5B) providing an indication to the user of the model output.

FIG. 5D illustrates a user interface 530 where after the user adds the text “in front of a lake” to the text prompt, the intensity of the color overlay 531 decreases as an indication that an output image is being generated. In some embodiments, when the output image is generated by the selected machine-learning model, the output image 541 transitions in with a fade and overlays on top of the previous output image (e.g., the image of FIG. 5E may replace the image of FIG. 5D).

FIG. 5E illustrates an example user interface 540 that includes a subsequent output image 541 in response to the updated prompt “Image of a snowy mountain in front of a lake” in the text field 532 of FIG. 5D. In FIG. 5E, the user further continues to add input “with people” to the text field 542.

FIG. 5F illustrates an example user interface 550 that includes an output image 551 that is further updated from that of FIG. 5E and is responsive to the additional “with people” part added to the prompt from FIG. 5E of “Image of a snowy mountain in front of a lake with people” in the text field 542. The color overlay is reduced progressively as the image is refined in response to updates to the prompt.

FIG. 5G illustrates an example user interface 560 where the text prompt is modified to “Image of a snowy mountain in front of a like with people hiking on it” in the text field 562. FIG. 5H illustrates an example user interface 570 with the output image 571 that includes people hiking on a snowy mountain. This output image 571 is substantially different from the output images in the previous figures in response to making the hikers more of a central focus of the output image 571. For example, in FIG. 5F the output image 551 also includes hikers 552, but they are small in size and are not the focus of the output image 551. In some embodiments, when the user stops providing input, the color overlay that makes the output image 551 appear faded is entirely removed and the output image 571 is shown in full color.

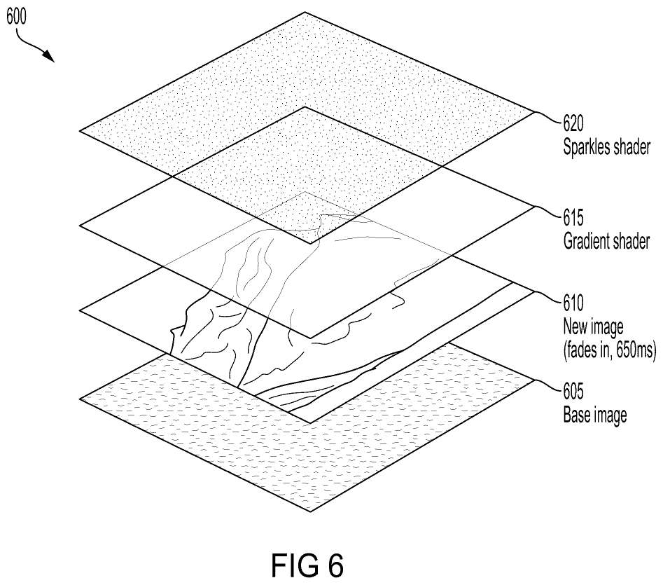

In some embodiments, during transitions between output images, one or more of the output images include multiple layers with different features. FIG. 6 illustrates example layers for an output image 600, according to some embodiments described herein. In this example, the output image includes a base image 605, a new image 610 (i.e., the output image generated by the machine-learning model), a gradient shader 615, and a sparkles shader 620. The base image 605 was generated responsive to a previous prompt, the new image 610 (displayed as a fade-in over the base image) is responsive to an updated prompt, and the gradient shader 615 and sparkles shader 620 provide the color overlay indicating that the image is progressively refined as the user continue to update the text prompt. The generated images in FIGS. 5C-5G are each represented using the multiple layers illustrated in FIG. 6, while that of FIG. 5H only shows the output image 571 since the user has completed entering the prompt.

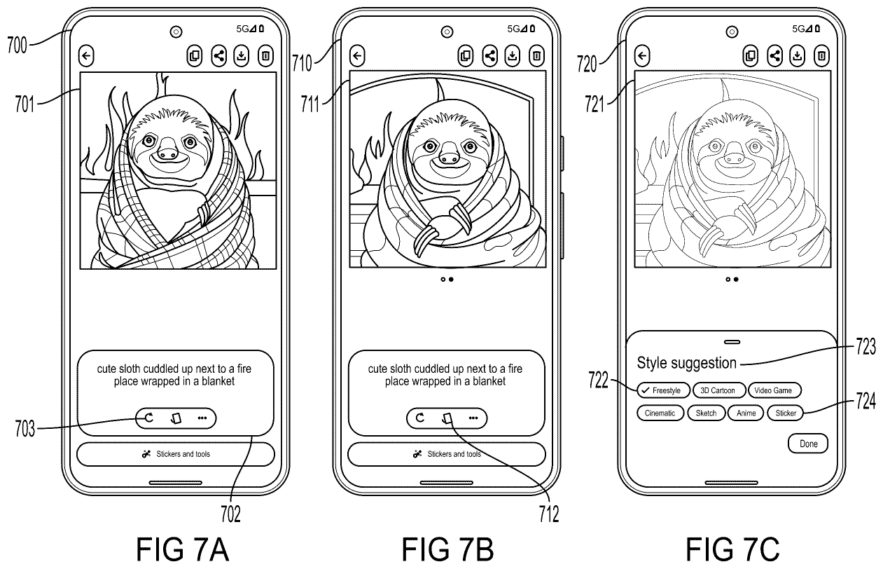

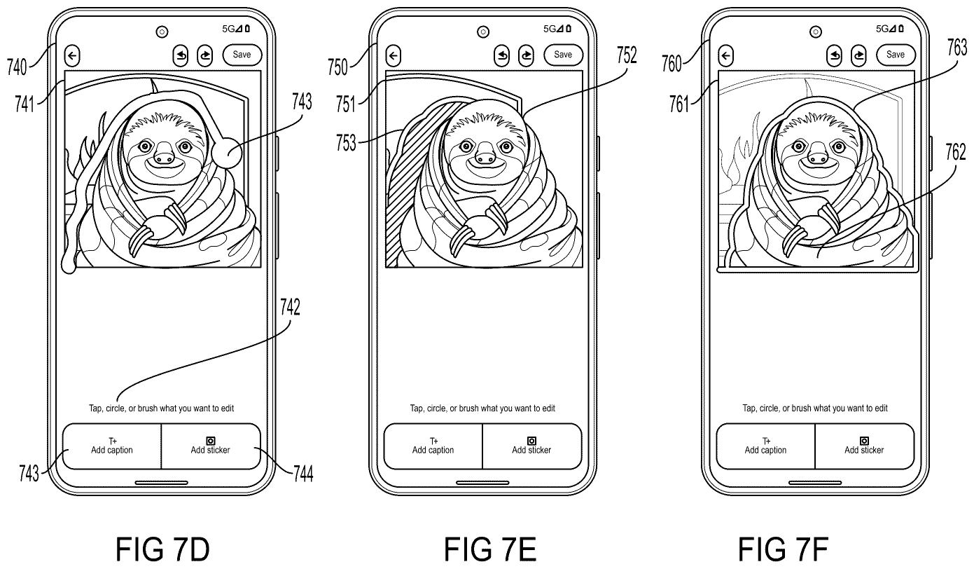

FIGS. 7A-7F respectively illustrate example user interfaces 700, 710, 720, 740, 750, 760 for generating an output image from text, requesting a subsequent output image, requesting a subsequent output image in a different style, and generating a sticker from the output image, according to some embodiments described herein.

FIG. 7A illustrates a user interface 700 where a user provided the following text prompt in the text field 702: “cute sloth cuddled up next to a fire place wrapped in a blanket.” A machine-learning model is selected from a set of machine-learning models that is a text-to-image machine-learning model that is trained on a more cartoonish version of a sloth. The selected machine-learning model generates an output image 701 that satisfies the textual prompt. If a user is not satisfied with the output image 701, the user may select a regenerate button 703, which provides a request to the user interface module 202 to generate another version of the output image.

Responsive to the user selecting the regenerate button 703 in FIG. 7A, the selected machine-learning model generates a subsequent output image 711 that is illustrated in the user interface 710 of FIG. 7B. The subsequent output image 711 includes a sloth with a slightly different pattern and a different pattern on the blanket (e.g., the blanket in FIG. 7A is red and the blanket in FIG. 7B is blue). If a user wants to change a style of the subsequent output image 711, the user may select a style button 712.

FIG. 7C illustrates a user interface 720 that includes different suggested styles for an output image. The output image 721 was generated using a freestyle style, as indicated by the freestyle button 722 being checked. Other options in the style suggestion section 723 may include 3D cartoon, video game, cinematic, sketch, anime, and sticker. Other styles are possible. For example, the user may specify a style in a text field, such as the text field 702 in FIG. 7A.

Responsive to the user selecting the sticker button 724 in FIG. 7C, the user interface module 202 generates the user interface 740 in FIG. 7D. The user interface 740 includes the instruction 742 of “tap, circle, or brush what you want to edit.” In this case, the user is in the process of circling the sloth using an indicator 743.

In some embodiments, the user may tap a user interface to select an object. If one or more objects exist in an image, the user may tap multiple times until an object that the user wants is highlighted. In some embodiments, the taps are enabled by the segmenter 204 segmenting objects from the image such that when a user taps pixels that are part of a particular object, the segmentation (e.g., from a segmentation mask that identifies pixels that are associated with each object) results in all pixels associated with an object being highlighted.

Once the object is selected in the output image 741, the user may select the “add caption” button 744 to add a caption to the resulting sticker. The user selects the “add sticker” button to instruct the selected machine-learning model to generate a sticker. The selected machine-learning model may be trained to generate stickers.

FIG. 7E is a user interface 750 that illustrates an output image 751 with a first version of a sticker 752. The sticker 752 is shown as separable from the background 753.

FIG. 7F is a user interface 760 that illustrates an output image 761 that includes a sticker 762 where the background is transparent. The sticker is illustrated with a white line 763 that surrounds the image to make it resemble a physical sticker.

A sticker can be used with a variety of applications. In some embodiments, the sticker has a more cartoonish look, such as the images in FIGS. 7A-7F. In some embodiments, the stick has a more realistic look and does not include a white line. For example, a user may provide a text prompt in a text field, such as “make a sticker of a car that is realistic and that does not have a line around it.”

In some embodiments, the user interface module 202 provides a user with an option to apply the sticker to different situations. For example, the user interface module 202 may provide the sticker to a messaging application. The messaging application may include a sticker section, similar to how many messaging application currently have a stored photos section, a GIF section, an emojis section, a meme section, etc.

In some embodiments, the user interface module 202 receives a request from a user to add the sticker to another image. For example, the user interface module 202 may include an upload button where a user can provide the sticker along with a request to create an image that includes the sticker along with other instructions for how the output image should look.

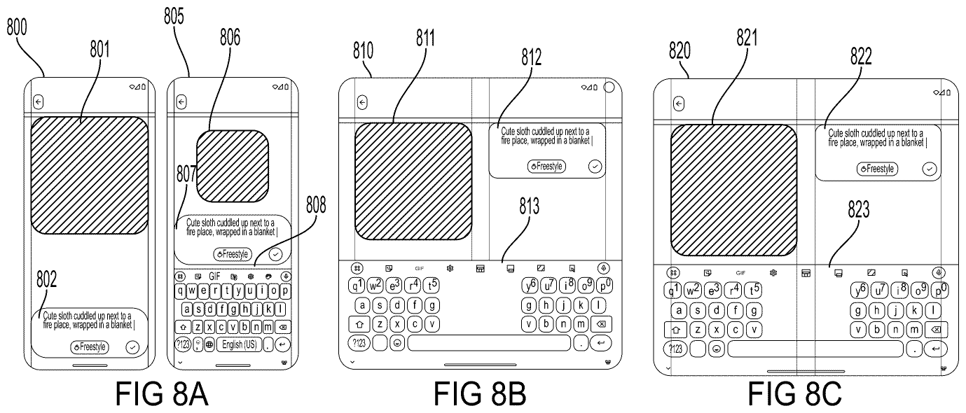

FIGS. 8A-8C respectively illustrate example configurations 800, 810, 820 of an introductory user interface based on different configurations of a foldable user device and based on different types of user device models, according to some embodiments described herein.

FIG. 8A illustrates two example configurations 800, 805 of a mobile device that is in a folded portrait position. In the first configuration 800 for a mobile device, the mobile device is in portrait mode where the image 801 and the text field 802 take up most of the width of display. In the second configuration 805 for a mobile device, the configuration 805 is also in portrait mode, but the image 806 and the text field 807 take up a smaller portion of the width of the frame, while a virtual keyboard 808 takes up the width of the frame.

FIG. 8B illustrates an example configuration 810 of the mobile device in an unfolded portrait mode. In the unfolded portrait mode, the left portion of the mobile device includes the image, the right side of the mobile device includes the text field 812, and the virtual keyboard 813 spans both sides of the mobile device.

FIG. 8C illustrates an example configuration 820 of the mobile device in an unfolded landscape mode. In the unfolded landscape mode, the image 821 takes up more vertical space as compared to the unfolded portrait mode illustrated in FIG. 8B. The text field 822 has similar dimensions as compared to the unfolded portrait mode illustrated in FIG. 8B. The virtual keyboard 823 spans both sides of the mobile device.

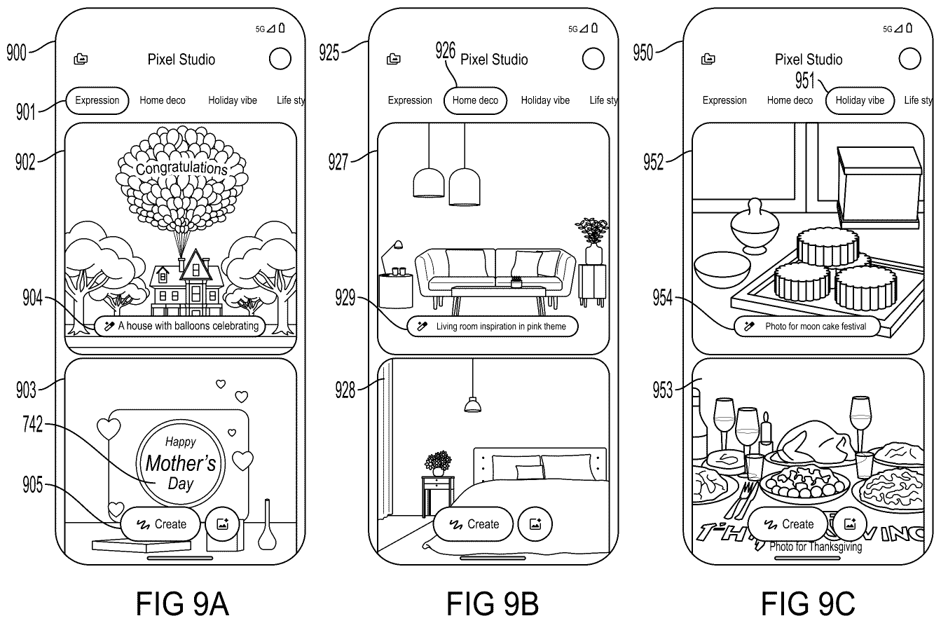

FIGS. 9A-9C respectively illustrate example user interfaces 900, 925, 950 with example output images for different categories, according to some embodiments described herein.

FIG. 9A illustrates an example user interface 900 with output images 902 and 903 associated with an “expression” category 901 is selected. Other types of categories include “home deco,” “holiday vibe,” and “life style.” The first output image 902 is a congratulations card that is based on a text prompt that states: “A house with balloons celebrating.” A user may add additional text, for example, to specify what type of event is being celebrated by selecting the text field 904 and adding more to the text prompt. The second output image 903 is a Mother's Day card.

The user interface 900 includes a create button 905 that a user may select to provide a text prompt. The user interface module 202 associates the text prompt with the “expression” category 901. In some embodiments, the categories displayed by the user interface module 202 are different each day to provide variety.

FIG. 9B illustrates an example user interface 925 with output images 927 and 928 where the “home deco” category 926 is selected. The first output image 927 is of a living room and the second output image 928 is of a bedroom. A user may change the first output image 927 by selecting the text field 929 and adding more to the text prompt.

FIG. 9C illustrates an example user interface 950 with output images 952 and 953 where the “holiday vibe” category 951 is selected. The first output image 952 celebrates the Lunar New Year with mooncakes and the second output image 953 celebrates Thanksgiving with a turkey, sides, and wine. A user may change the first output image 952 by selecting the text field 954 and adding more to the text prompt.

FIG. 10A illustrates a user interface 1000 where a user has provided a text prompt in the text field 1001 for “a man reading a book,” and the output image is a sticker 1002. The user interface 1000 includes additional options for animating the sticker by selecting the “animate sticker” button 1003, or saving the sticker to the user's library, using the “add to library” button 1004.

FIG. 10B illustrates a user interface 1025 that includes presets 1026 for generating an animated sticker. In this example, the presets 1026 include: just animate, express love, say “Hi”, celebrate, say “No”, and feel sad. Other presets may be used. The user interface 1025 also includes a text field 1027 in case the user wants to provide a subsequent prompt that describes an action to be performed as an animation. Responsive to a user selecting the “feel sad” button 1028 in FIG. 10B, the selected machine-learning model generates an animated sticker.

FIG. 10C illustrates a user interface 1050 that includes an animated sticker 1052. In this example, the animation shows the man crying tears as he reads his book. The user interface 1050 also includes a “regenerate” button 1053 to request the selected machine-learning model to generate another version of a “feel sad” animation.

### Image-to-Image Interfaces

In some embodiments, the user interface module 202 receives initial images from a user. The initial images may be received from the camera 243 of the computing device 200, from storage on the computing device 200, or from the media server 101 via the I/O interface 239.

Before the initial image is processed, the user interface provides a user with a request for user consent to modify the image. In some embodiments, such consent may be obtained once by the media application 103 for all future images. The user is provided with options to revoke such one-time consent and to require consent for each image. The user interface module 202 does not collect or make use of user information unless the user provides user consent.

The initial image may include one or more objects. In some embodiments, the initial image also includes one or more human subjects (e.g., one or more objects in the initial image may correspond to a human subject, e.g., a human face, a human body, etc.). In some embodiments, the user interface module 202 receives user input that selects the one or more objects in the initial image. The user input may include surrounding the one or more objects in the initial image (e.g., by drawing a circle or other shape around an object that at least approximately encloses object), moving a finger over the one or more objects, tapping on the one or more objects in the initial image, providing a textual identification of the one or more images, etc.

The user interface may highlight the one or more objects in response to receiving the user input. In some embodiments, where a tap may be associated with multiple objects, a different number of taps may cause the user interface to highlight different objects. For example, where the initial image is a beach scene and a pail is in front of a sandcastle, tapping on the pail/sandcastle area a first time causes the pail to be highlighted first, tapping on the pail/sandcastle area a second time causes the sandcastle to be highlighted, and tapping on the pail/sandcastle area a third time causes both the pail and the sandcastle to be highlighted.

The user interface includes an option for providing a text prompt associated with the one or more selected objects in the initial image. For example, the user interface may include a text field where the user directly inputs the text prompt, a text field with a preset, a microphone button for providing audio input that is converted to a textual request, etc.

In some embodiments, the user interface module 202 generates presets that are displayed in the user interface. The presets may be customized based on parameters such as the type of objects and regions in the initial image. The user interface module 202 may receive segmentation information from the segmenter 204 that divides the initial image into different sections. The user interface module 202 may generate different presets based on the segmentation. In some embodiments, the user interface module 202 performs object recognition to identify types of objects in the different segments of the initial image. For example, the initial image may be divided into a background and have presets related to a background (e.g., change sky to different types of sky, change buildings to different types of buildings, change water bodies to different types of water bodies, etc.), one or more objects, etc.

In some embodiments, the initial image is of a user and the initial image is used by a selected machine-learning model to generate an avatar. In some embodiments, the avatar includes a full person; in some embodiments, the avatar includes a subset of the user, such as the user's face. In some embodiments, the avatar is referred to as a face model. In some embodiments, the avatar includes non-human subjects, such as pets.

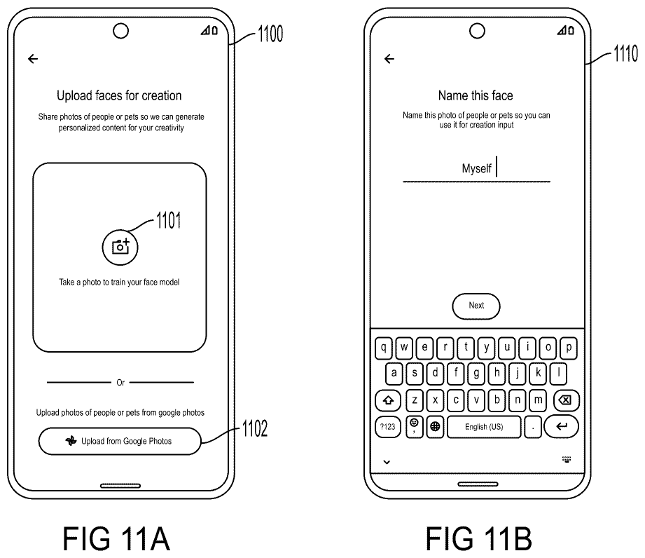

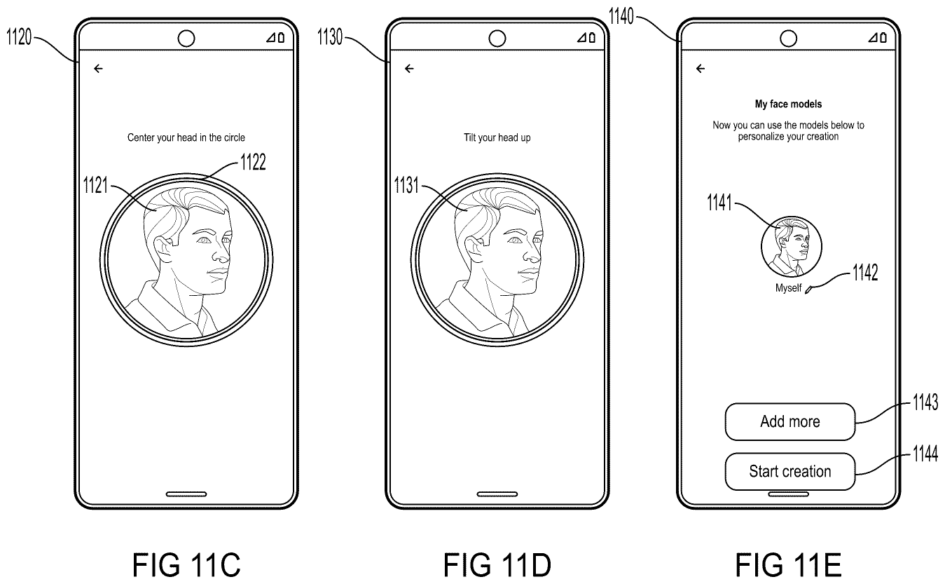

FIGS. 11A-11E respectively illustrate example user interfaces 1100, 1110, 1120, 1130, 1140 for generating a face model, according to some embodiments described herein. In FIG. 11A, the user may select the camera button 1101 to provide permission for the camera 243 to capture a live image of the user. The user may select the “upload from Google photos” button 1102 (or other analogous button) to select a previously captured image of the user.

FIG. 11A illustrates a user interface 1100 that instructs a user to capture an image (or multiple images/video) of the user for generating the face model. The user is provided with guidance regarding the face model, how the face model may be used to generate images (e.g., that include generated images that include the face), and how the face model is stored, etc. If the user chooses to accept the applicable terms and conditions, and provides permission, the process of generating the face model is initiated. The user can choose to not use a face model, in which case no images are captured and no face model is generated. The face model creation feature is provided only in certain states/countries, where the creation, storage, and use of a face model is permitted, and in accordance with applicable regulations. In some embodiments, the image of the user is uploaded for use in creating the face model. Once the face model is generated, the user interface module 202 deletes the captured images of the user. In some embodiments, identifying information associated with the user is removed from the face model. The face model is stored locally on the computing device 200 and is used specifically with user permission and in compliance with applicable regulations.

FIG. 11B illustrates an example user interface 1110 that asks a user to provide a name for the face model. In this example, the face is named “Myself.”

FIG. 11C illustrates an example user interface 1120 that includes a live image 1121 of a user where the image 1121 moves as the user moves. The user interface 1120 guides the user to move their head to be centered in the circle so that the camera 243 captures an image that can be used to create the face model. In some embodiments, the color of the circle surrounding the image 1121 is illustrated with different colors (e.g., green for good, red for bad, etc.) to provide a visual indicator to the user to change their position.

FIG. 11D illustrates an example user interface 1130 that includes a live image 1131 of the user. The user interface 1130 guides a user to tilt their head upwards for one or more additional images to be captured that are used to generate the face model. Once the face model is complete, a selected machine-learning model generates a face model.

FIG. 11E illustrates an example user interface 1140 that includes the resulting face model 1141, the name for the face model (e.g., “Myself”) 1142 along with a pencil icon in case the user wants to change the name, an option to add another face model by selecting the “add more” button 1143, and an option to start creating output images that could include the face model by selecting the “start creation” button 1144. In some embodiments, the face model may be stored as an embedding that can be provided as input to the selected machine-learning model, e.g., to guide the model to generate images that include a face that matches the face model (e.g., a cartoon avatar, a 3D avatar face, etc.).

In some embodiments, an avatar (such as the face model) may be used by a selected machine-learning model to generate subsequent output images. The user interface module 202 may provide multiple options for identifying the avatar. In some embodiments, the user interface module 202 generates a user interface that includes names and/or images of available avatars and a user may select a particular avatar to add it to a text field that is used for a prompt. In some embodiments, an avatar may be identified by using an “@” symbol, such as “@Sara” to refer to an avatar associated with Sara.

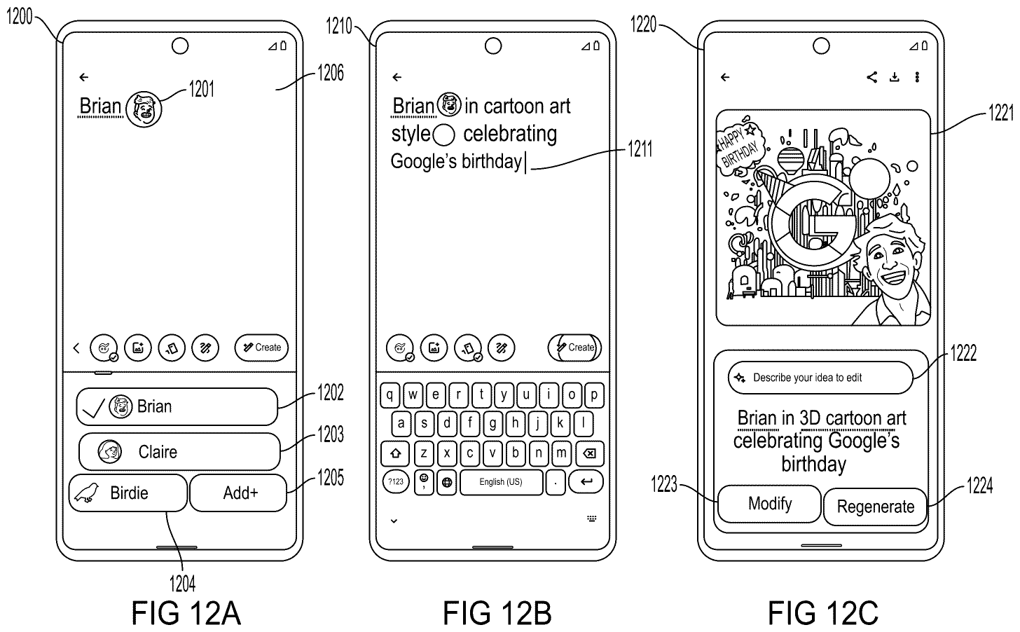

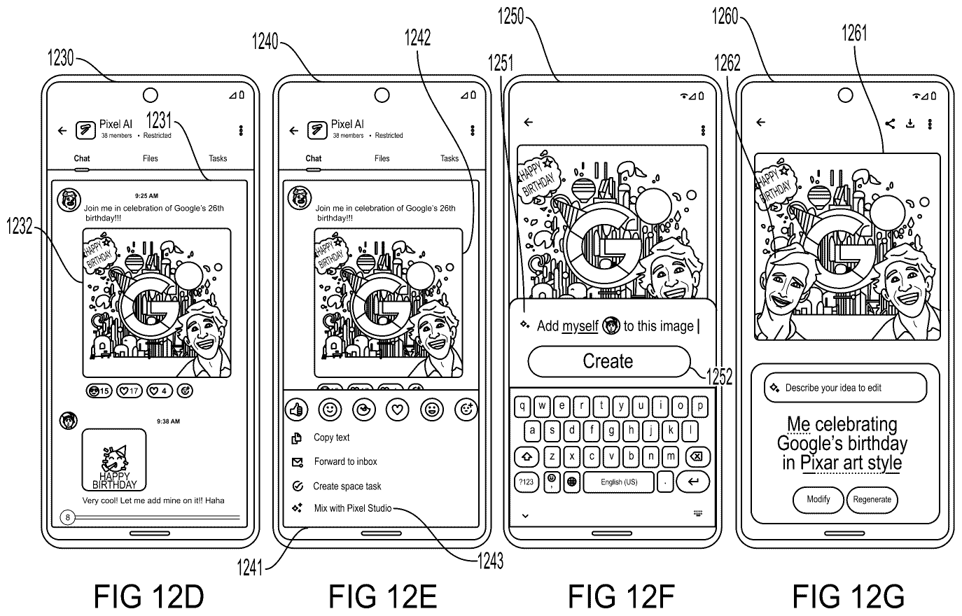

FIGS. 12A-12G respectively illustrate example user interfaces 1200, 1210, 1220, 1230, 1240, 1250, 1260 for using text and faces to request an output image, according to some embodiments described herein.

FIG. 12A illustrates an example user interface 1200 that includes three face models that were generated by the selected machine-learning model that are available to be used by the selected machine-learning model to generate a subsequent output image. The input field 1206 includes “Brian” and an image of Brian 1201 that was selected from the selectable button for Brian 1202 at the bottom of the user interface 1200. The selectable button for Brian 1202 includes a checkmark to indicate that it was selected for the input field 1206. The additional face models include a selectable button for Claire 1203 and a selectable button for Birdie 1204. Birdie may be a face avatar for a pet associated with the user. An add button 1205 allows the user to add other avatars to the input field 1206.

FIG. 12B illustrates an example user interface 1210 that continues with the example in FIG. 12A. The user has specified in the input field 1211 that the face model for Brian should be generated “in cartoon art style celebrating Google's birthday.” As a result, the prompt engine 206 will select a machine-learning model from a set of machine-learning models that is trained to generate output images in a cartoon art style.

FIG. 12C illustrates an example user interface 1220 of the resulting output image 1221 that was requested in FIG. 12B. The user interface 1220 in FIG. 11C includes options for modifying the output image 1221 by changing the prompt using the input field 1222 and then selecting the “modify” button 1223 or by selecting the “regenerate” button 1224, which causes the selected machine-learning model to generate a subsequent output image.

Once the user is satisfied with the output image, the user can save the output image or the user interface module 202 can add the subsequent output image to a folder. The user may access the output image in a different application, such as a messaging application.

FIG. 12D illustrates an example user interface where the output image 1221 from FIG. 12C is added to a chat 1231. Other users may comment on the output image 1232 in the chat 1231, add reactions, etc.

FIG. 12E illustrates a user interface 1240 that includes options 1241 associated with the output image 1242, which includes copying the text, forwarding the output image to an inbox, creating a task associated with the output image, or an option for modifying the output image. The user selects the option for modifying the output image by selecting the “mix with Pixel Studio” selectable link 1243.

FIG. 12F illustrates an example user interface 1250 with an input field 1251 where the user adds a prompt to add the user to the output image. In this example, even though the user is using a messaging application that is separate from the media application 103, the messaging application includes functionality from the media application 103. In some embodiments, the messaging application includes a plug-in that enables access to the functionality form the media application 103. Once the user is satisfied with the prompt in the input field 1251, the user selects the “create” button 1252.

FIG. 12G illustrates an example user interface 1260 with an output image 1261 generated by the selected machine-learning model that adds the face model 1262 for the user to the output image 1242 in FIG. 12E.

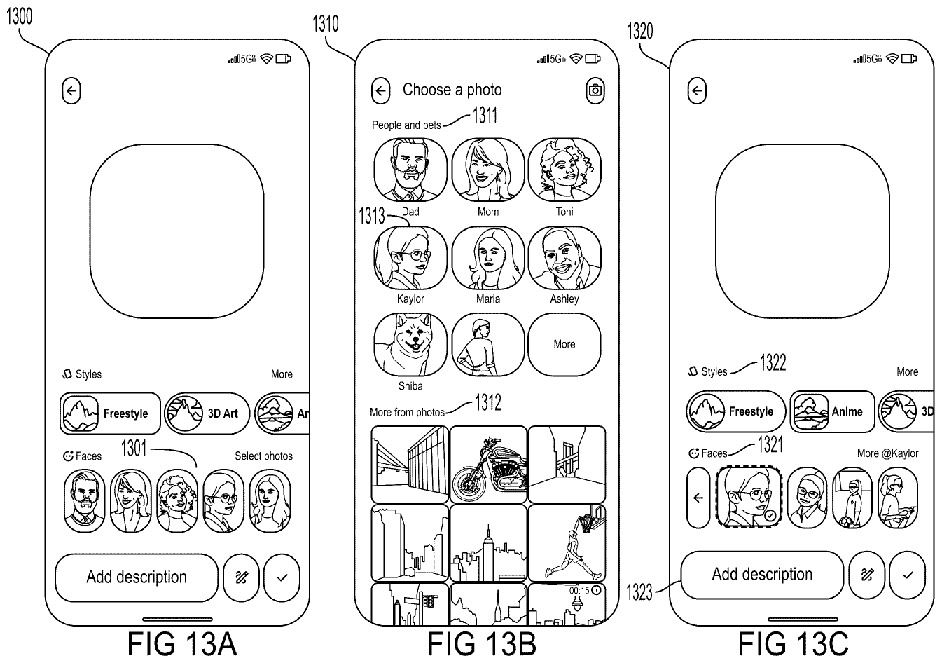

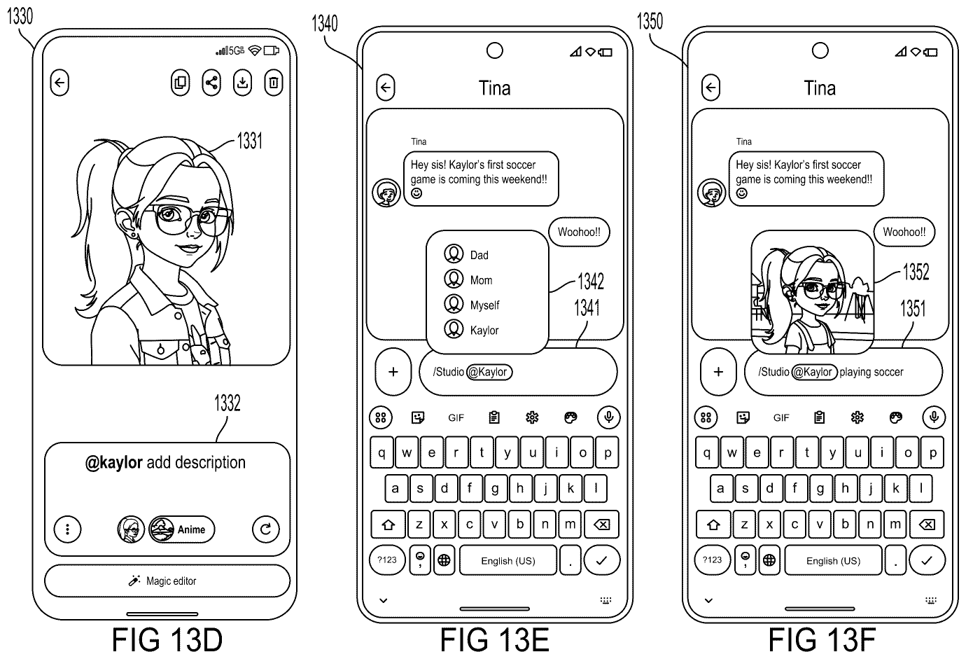

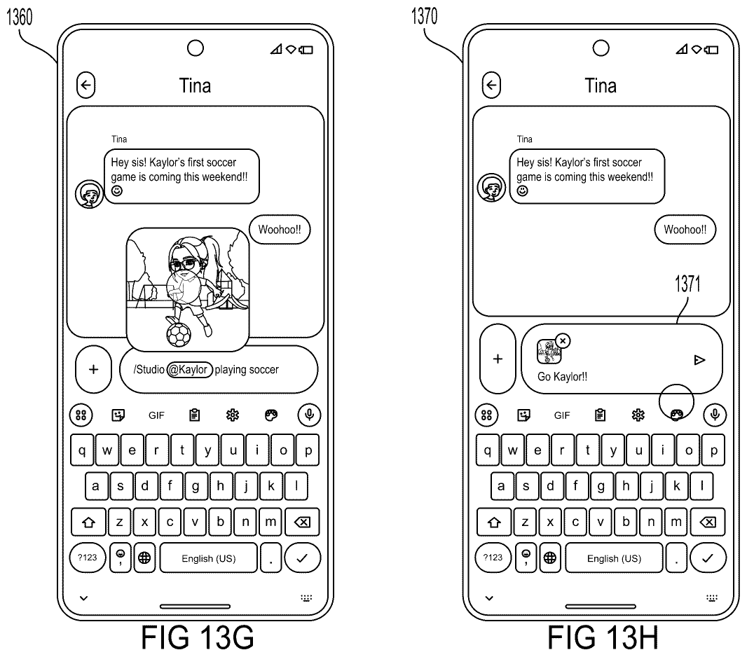

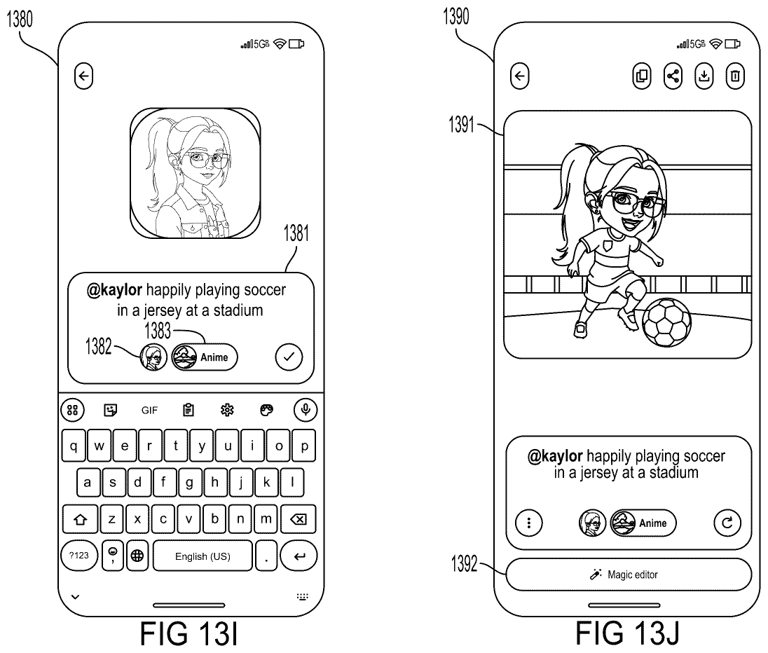

FIGS. 13A-13J illustrate example user interfaces 1300-1390 for generating output images of an avatar, according to some embodiments described herein.

FIG. 13A illustrates a user interface 1300 of a landing page where a user may select different options for generating an avatar. For example, the user may select a particular style for the avatar or select a photo that is used as a model for the avatar. In this example, the user selects the photos section 1301.

FIG. 13B illustrates a user interface 1310 that is displayed responsive to the user selecting the photos section 1301 in FIG. 13A. The user interface 1310 includes a “people and pets” section 1311 with images of different people where each person and/or animal is associated with multiple images. The user interface 1310 also includes a “more from photos” section with other images captured by the user. In this example, the user selects the image 1313 of Kaylor.

Responsive to the user selecting the image 1313 of Kaylor in FIG. 13B, the user interface module 202 generates a user interface 1320 that includes multiple faces 1321 of Kaylor in FIG. 13C. The user interface 1320 also includes options for selecting presets of styles 1322, such as freestyle, anime, and 3D, as well as a text field 1323 where a user may provide a text prompt.

Responsive to the user selecting a particular image of Kaylor and the anime style in FIG. 13C, the user interface module 202 generates a user interface 1330 in FIG. 13D that includes an avatar 1331 of Kaylor. The text field 1332 also includes an indication that the avatar 1331 may be referred to as “@kaylor.”

In some embodiments, the user interface module 202 provides the avatar to a different application. The application may be stored on the same computing device 200 as the media application 103 or a computing device. For example, the following user interfaces illustrate a messaging application that can generate output images that include the avatar.

FIG. 13E illustrates a user interface 1340 of group texts between Tina and other members of her family. A user states: “Hey sis! Kaylor's first soccer game is this weekend!! [symbol] ” The user interface 1340 includes a text field 1341 where the user has invoked the avatar for Kaylor by typing “/Studio @Kaylor.” The user interface also includes a pop-up 1342 with all the face models available.

FIG. 13F illustrates a user interface 1350 where the user continues to type in the text field 1351. In addition to invoking the Kaylor avatar, the text prompt includes the instruction “playing soccer.” The user interface 1350 also includes an image 1352 of Kaylor.

FIG. 13G illustrates a user interface 1360 that includes a video of Kaylor playing soccer. In this example, the user provided a text prompt for the selected machine-learning model to generate an output video that includes the Kaylor avatar performing the action of playing soccer.

FIG. 13H illustrates a user interface 1370 that includes a text field 1371 where the user can add the output video to the chat along with “Go Kaylor!”

FIG. 13I illustrates a different embodiment of the user interface 1380 where instead of adding Kaylor avatar to a group text, a user stays with the media application 103 and generates a prompt for the Kaylor avatar to be added to an output image. Specifically, the input field 1381 includes “@kaylor happily playing soccer in a jersey at a stadium” along with an icon of the Kaylor avatar 1382 and an anime preset 1383.

As a result of the prompt and the preset in FIG. 13J, the selected machine-learning model generates a subsequent output image 1391 that is illustrated in the user interface 1390 in FIG. 13J. If the user wants to further modify the subsequent output image 1391, the user may select the “magic editor” button 1392.

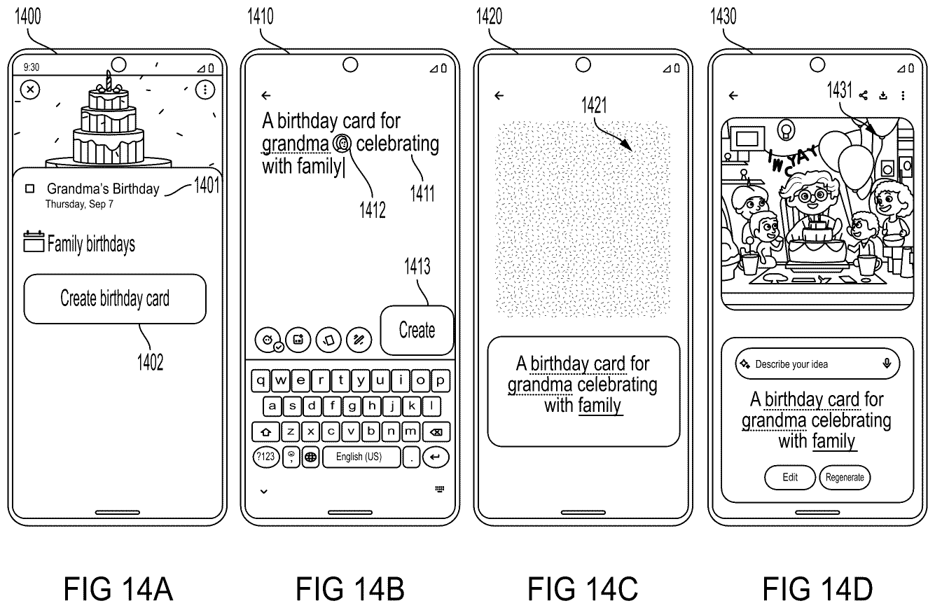

FIGS. 14A-14D respectively illustrate example user interfaces 1400, 1410, 1420, 1430 for generating a personalized birthday card that is associated with a calendar event, according to some embodiments described herein.

FIG. 14A illustrates an example user interface 1400 of a calendar item for Grandma's Birthday and an option to create a birthday card. The user interface 1400 lists the calendar item 1401 as “Grandma's Birthday,” which occurs on September 7th. The user interface 1400 includes a “create birthday card” button 1402.

Responsive to a user selecting the “create a birthday card” button 1402 in FIG. 14A, FIG. 14B illustrates a user interface 1410 for providing details about the birthday card to be generated. FIG. 14B includes an input field 1411 where the user provides the following text prompt: “A birthday card for grandma celebrating with family,” which also includes an avatar for grandma 1412. The user selects the “create” button 1413 to provide the prompt to the prompt engine 206.

FIG. 14C illustrates an example user interface 1420 with a blurry screen 1421 to indicate that a selected machine-learning model is generating the user interface.

FIG. 14D illustrates an example user interface 1430 that includes the output image 1431 generated by the selected machine-learning model. The output image 1431 is a birthday card that may be added to the calendar invitation.

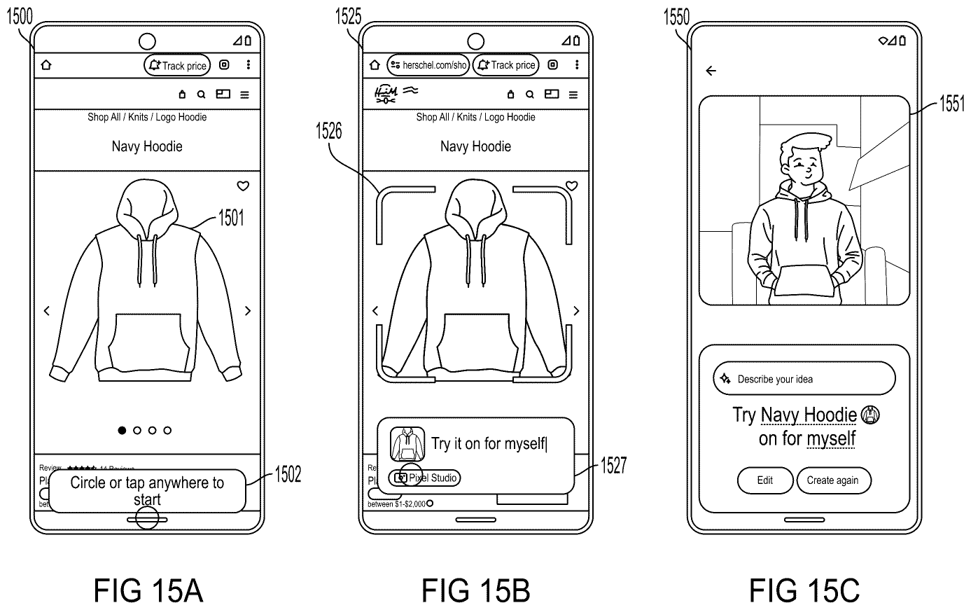

FIGS. 15A-15C illustrate example webpages 1500, 1525 and a user interface 1550 for generating an output image of a user wearing clothing, according to some embodiments described herein.

FIG. 15A illustrates an example webpage 1500 that is displayed in a browser with instructions to “click or tap anywhere to start.” In some embodiments, the browser includes a plug-in that is associated with the media application 103. The webpage 1500 includes an image of a hoodie 1501 and text that states: “circle or tap anywhere to start” 1502. The user selects the navy hoodie 1501.

FIG. 15B illustrates an example webpage 1525 with the navy hoodie selected as indicated by the lines 1526 surrounding the hoodie. The webpage 1525 includes an input field 1527 where a user has provided the text prompt: “Try it on for myself.”

FIG. 15C illustrates an example user interface 1550 that includes an output image 1551 of the user wearing the navy hoodie. In some embodiments, a selected machine-learning model generates the output image 1551 from a pre-existing image of the user where the user's clothing is replaced with the hoodie. In some embodiments, a selected machine-learning model generates the output image 1551 by combining an avatar with the hoodie and generating a background image. The output image 1551 advantageously allows the user to see what he looks like in the navy hoodie before he commits to purchasing the navy hoodie.

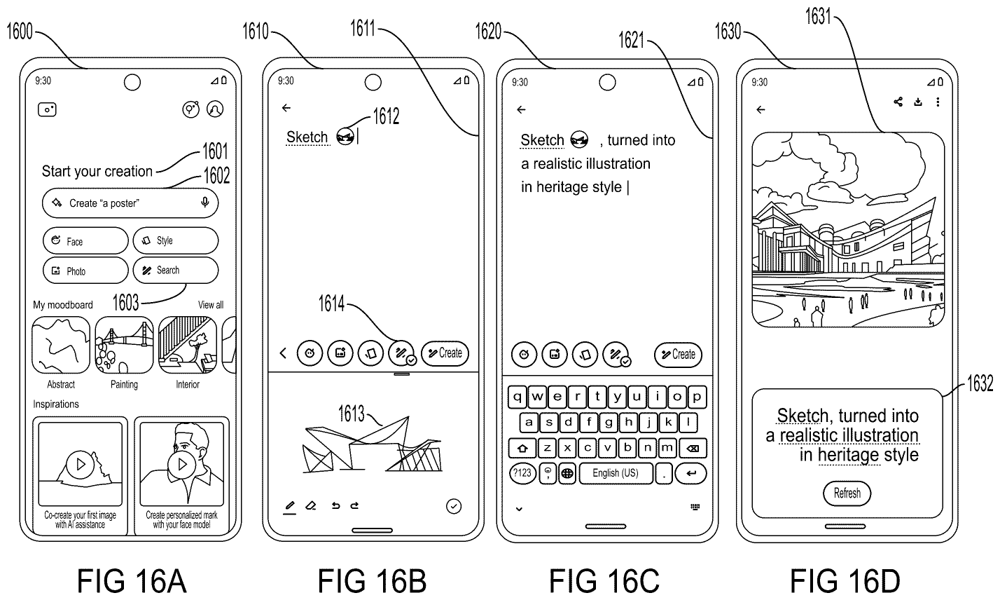

FIGS. 16A-16D respectively illustrate example user interfaces 1600, 1610, 1620, 1630 for generating an output image from a sketch, according to some embodiments described herein.

FIG. 16A illustrates an example user interface 1600 that includes different options for starting a creation 1601. The user interface 1600 includes a text field 1602 where a user can provide a text prompt. The user interface 1600 also includes different categories of output images, such as a face option for viewing face model options, a style option for viewing styles of output images that can be generated by the set of machine-learning models, a photo option for uploading an initial image and generating an output image from the initial image, and a sketch option 1603.

FIG. 16B illustrates an example user interface 1610 that is displayed responsive to a user selecting the sketch option 1603 in FIG. 16A. The user interface 1610 includes an input field 1611 where the user provides a text prompt as well as reference to a sketch 1612. In this example, the user has begun typing in the input field 1611 “sketch” and the reference to the sketch 1612. The user interface 1610 also includes a sketch field 1613 where the user can sketch. In this example, the user provided a sketch using the pen option 1614.

FIG. 16C illustrates an example user interface 1620 where the user added the following prompt to the input field 1621: “Sketch, turning into a realistic illustration in heritage style.”

FIG. 16D illustrates an example user interface 1630 that includes an output image 1631 generated by a selected machine-learning model to satisfy the prompt 1632.

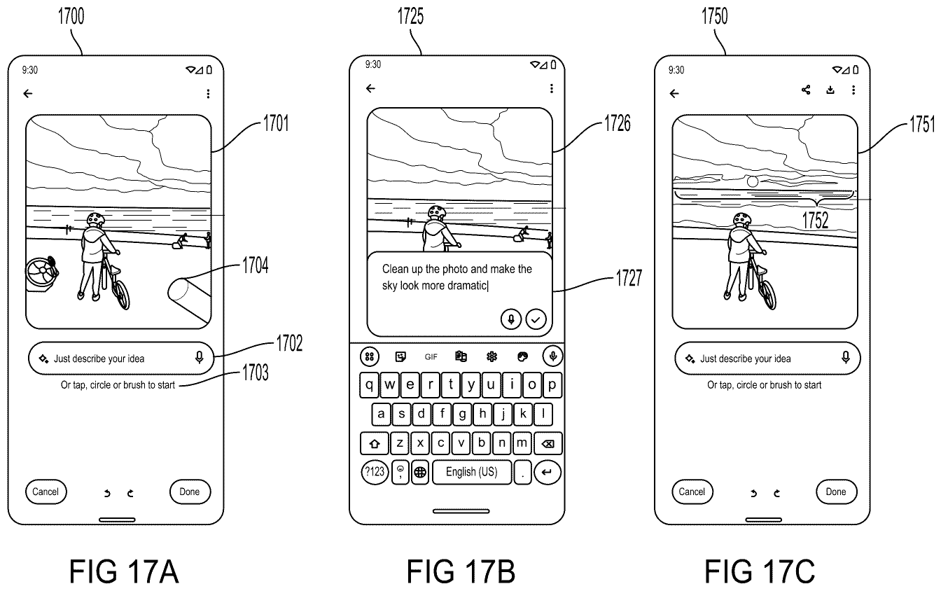

FIGS. 17A-17C respectively illustrate example user interfaces 1700, 1725, 1750 for using a conversational style to edit an initial image, according to some embodiments described herein.

FIG. 17A illustrates an example user interface 1700 of an initial image 1701, a text field 1702 that includes the instructions: “Just describe your idea,” and instructions 1703 beneath the text field: “Or tap, circle or brush to start.”

FIG. 17B illustrates an example user interface 1725 with the initial image 1726 and a text field 1727 with where a user provided the following text prompt: “Clean up the photo and make the sky look more dramatic.” The user provided text prompt 1727 (with automatic prompt rewrite) and the initial image 1726 are provided to a selected machine-learning model. For example, the selected machine-learning model may include a machine-learning model that is non-structure preserving and non-shape preserving and trained for photorealism.

FIG. 17C illustrates an example user interface 1750 with an output image 1751 generated by the selected machine-learning model. The trash (such as the object 1704 and other objects strewn about on the sandy beach) in the initial image 1701 in FIG. 17A is removed from the output image (responsive to “clean up the photo”) and the sky region 1752 in the output image 1751 is changed from cloudy with blue on the horizon in the initial image 1726 in FIG. 17B to a yellow horizon and darker colors in the ocean (responsive to the prompt in FIG. 17B that states: “make the sky look more dramatic”).

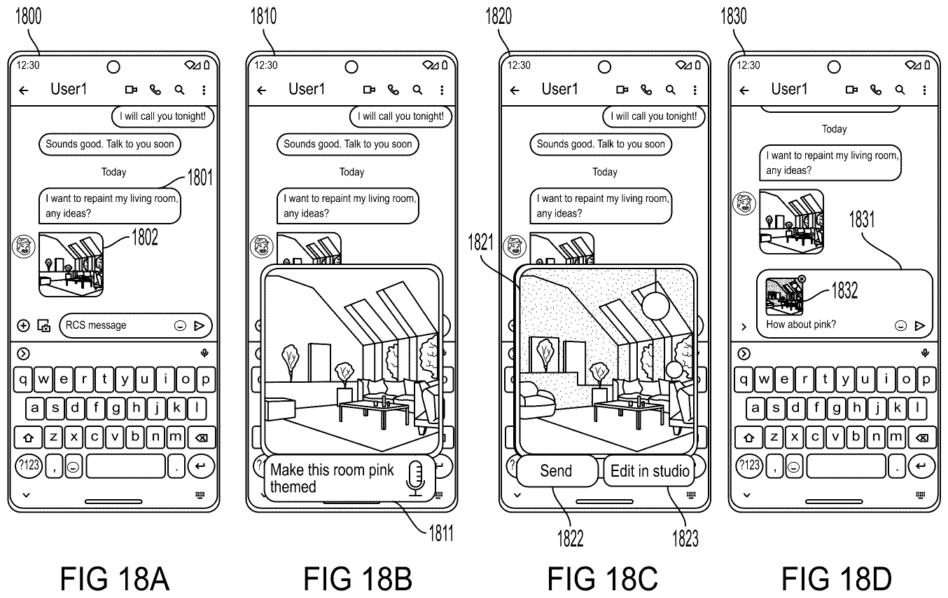

FIGS. 18A-18D respectively illustrate example user interfaces 1800, 1810, 1820, 1830 for using a conversational style for generating an output image of a room, according to some embodiments described herein.

FIG. 18A illustrates an example user interface 1800 that includes a chat between User1 and a second user. The second user asks in a text 1801: “I want to repaint my living room, any ideas?” The text also includes an image 1802 of a room.

FIG. 18B illustrates an example user interface 1810 where User1 clicked on the image 1802 in FIG. 18A and added the following audio command 1811: “Make this room pink themed.” In some embodiments, the messaging application provides the command to the media application 103 with the image and receives an output image from a selected machine-learning model associated with the media application 103.

FIG. 18C illustrates an example user interface 1820 with an output image 1821 generated by the selected machine-learning model that satisfies the audio command to change the initial image 1802 of FIG. 18A into an output image 1821 in FIG. 18C of a pink-themed room. If User1 is satisfied with the output image 1821, User1 may select the “send” button 1822 to add the output image 1821 to the text. If User1 wants to make additional changes to the output image 1821, the user may select the “edit in studio” button 1823 to switch to the media application 103.

Responsive to User1 selecting the “send” button 1822 in FIG. 18C, FIG. 18D illustrates an example user interface 1830 that includes a text field 1831 where the user has attached the output image 1832 in a text conversation with another user and added the following text: “How about pink?” In this example, the generative machine learning model was invoked from within the messaging application and the output image was made available for posting in a text. The seamless integration between the messaging application and the media application 103 improves the editing experience of the user.

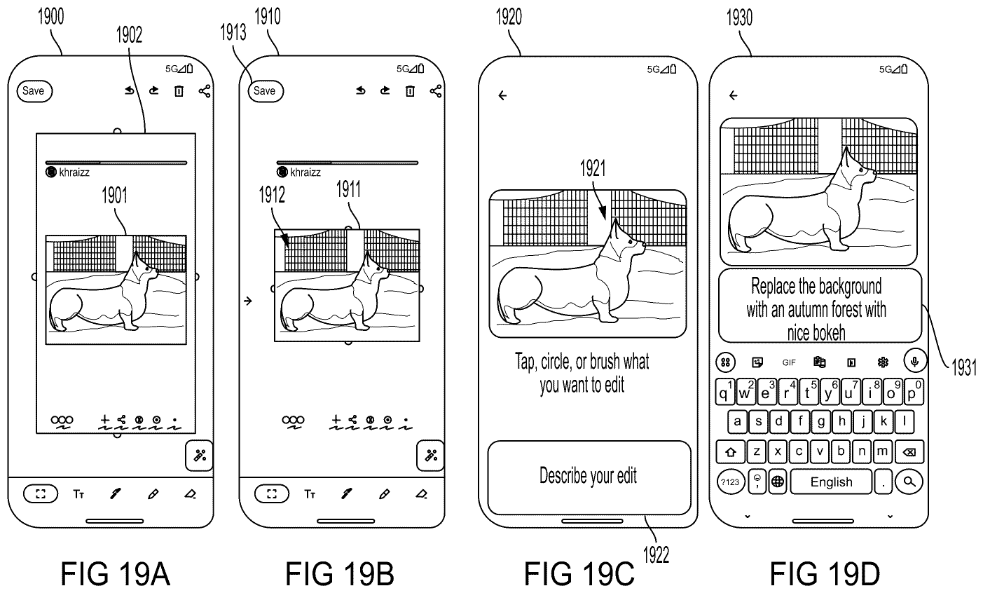

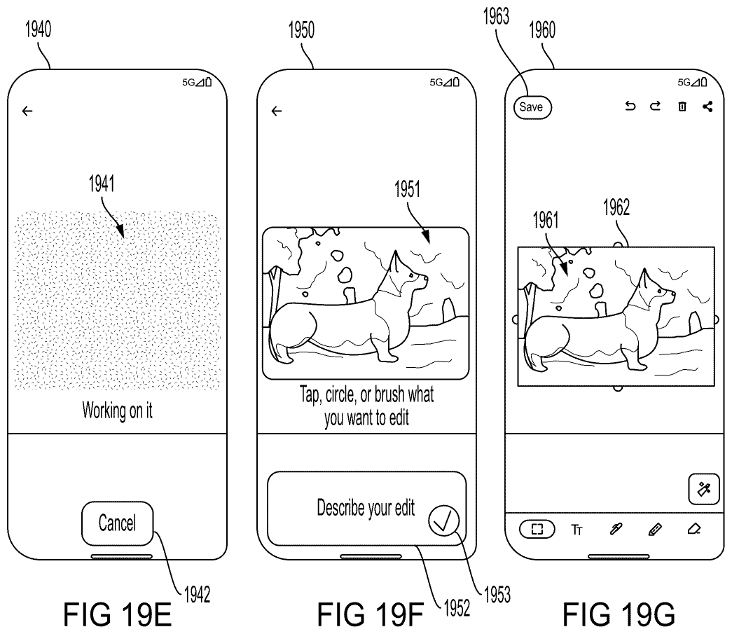

FIGS. 19A-19G respectively illustrate example user interfaces 1900, 1910, 1920, 1930, 1940, 1950, 1960 for using a conversational style for editing screenshots, according to some embodiments described herein.

FIG. 19A illustrates an example user interface 1900 of a screenshot 1901 of a dog. A user is in the process of cropping the screenshot 1901 using a rectangle 1902 to indicate the dimensions of the crop.

FIG. 19B illustrates an example user interface 1910 where a user has finished cropping the screenshot of the dog (as indicated by the rectangle 1911 matching the dimensions of the screenshot 1912) and selects a save button 1913.

FIG. 19C illustrates an example user interface 1920 of the cropped screenshot 1921 of the dog and a text field 1922 where the user is instructed to: “describe your edit.”

FIG. 19D illustrates an example user interface 1930 where the user provided the following text prompt in the text field 1931: “Replace the background with an autumn forest with nice bokeh.”

FIG. 19E illustrates an example user interface 1940 of a blurred background 1941 that indicates that a selected machine-learning model is generating the output image with the bokeh effect and a “cancel” button 1942 that the user may select to cancel the process.

FIG. 19F illustrates an example user interface 1950 with an output image 1951 generated by the selected machine-learning model. The background out the output image 1951 includes blurred leaves and trees, illustrating that the bokeh effect has been applied. The user interface 1950 includes a text field 1952 with an option for providing an additional text prompt and an option to select a checkmark 1953 to indicate that the user is done editing the output image.

Responsive to the user selecting the checkmark 1953 in FIG. 19F, FIG. 19G illustrates an example user interface 1960 that includes an option to further crop the output image 1961 using the rectangle 1962 and to save 1963 the output image 1961 including any changes made by cropping the output image 1961.

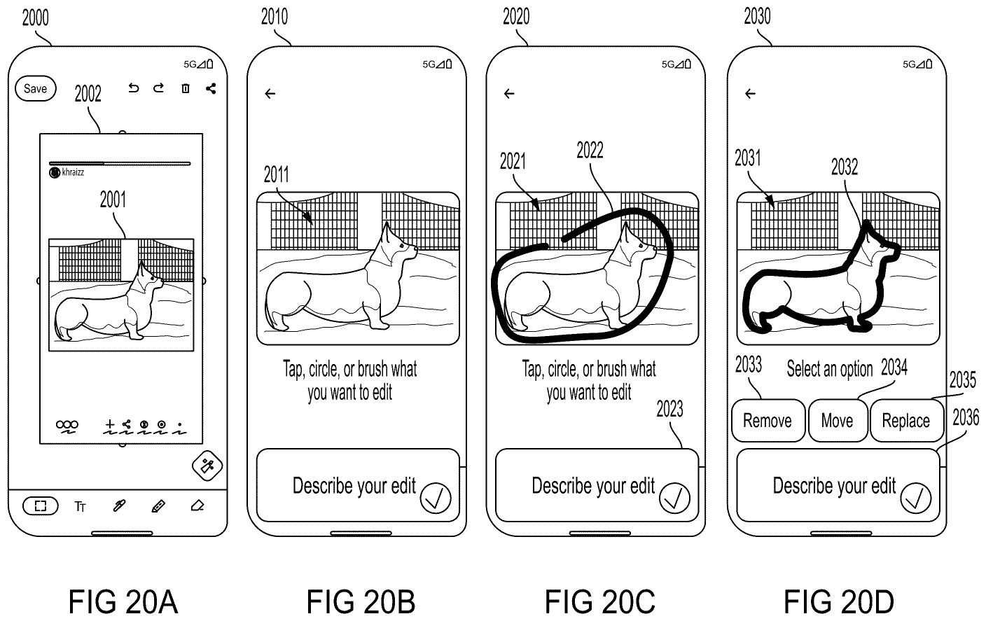

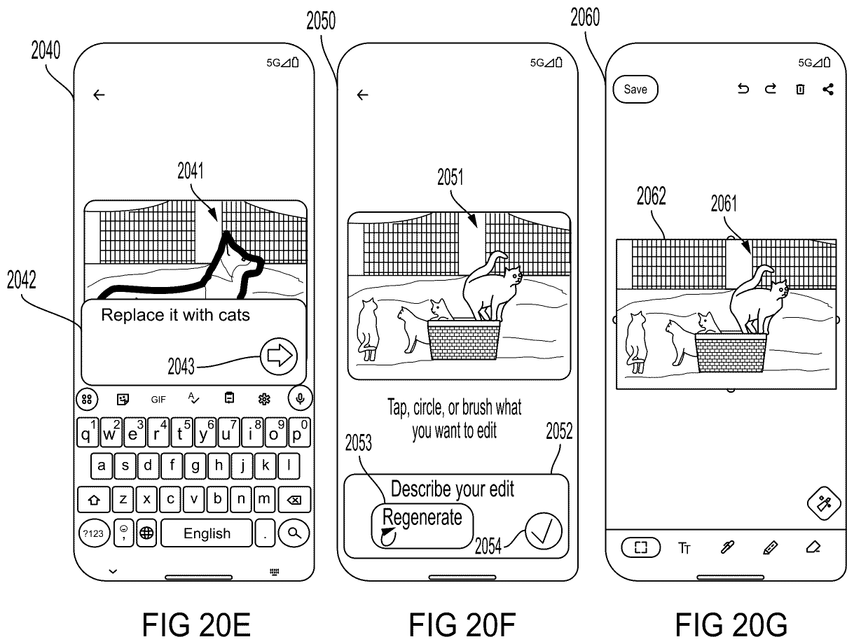

FIGS. 20A-20G respectively illustrate example user interfaces 2000, 2010, 2020, 2030, 2040, 2050, 2060 that support gesture editing, according to some embodiments described herein.

FIG. 20A illustrates an example user interface 2000 of a screenshot of a dog. A user is in the process of cropping the screenshot 2001 using a rectangle 2002 to indicate the dimensions of the crop.

FIG. 20B illustrates an example user interface 2010 where a user has finished cropping the screenshot of the dog and a resulting initial image 2011 is displayed.

FIG. 20C illustrates a user interface 2020 that includes an initial image 2021 and a user selection of an object in the initial image 2021. The user selection takes the form of a gesture that is a circle 2022 that surrounds the dog in the initial image 2021. The user may enter a text prompt in the text field 2023, which has the instructions “describe your edit.” If the user provides a text prompt, both the user selection of the object and the text prompt are used by the prompt engine 206 to generate a rewritten prompt that is provided as input to a selected machine-learning model.

FIG. 20D illustrates an example user interface 2030 that highlights the selected dog 2032 within the initial image 2031. In some embodiments, the user interface module 2020 receives a segmentation from the segmenter 204 (e.g., in the form of a segmentation mask that identifies pixels associated with the user selection) and generates the highlight of the selected dog 2032 responsive to receiving the segmentation.

The user interface 2030 includes a “remove” button 2033 that, responsive to being selected, provides a request to a selected machine-learning model to remove the dog from the initial image 2031. The user interface 2030 includes a “move” button 2034 that, responsive to being selected, moves the dog from a first location to a second location within the initial image 2031. As a result, a selected machine-learning model generates an output image with the dog at the second location within the image. The user interface 2030 includes a “replace” button 2035 that, responsive to being selected, replaces the dog with something else. For example, a user may specify what to replace the dog with by entering a text prompt in the text field 2036.

Responsive to the user selecting the “replace” button 2035 in FIG. 20D, FIG. 20E illustrates an example user interface 2040 that includes the selected dog in the initial image 2041 and the text field 2042 with the following text prompt: “Replace it with cats.” Once the user has completed the text prompt, the user selects the arrow button 2043 to process the request.

The text prompt and the user input are provided to the prompt engine 206 and are rewritten. For example, the rewritten prompt may include “replace the selected object with cats using a non-structure preserving and non-shape preserving machine-learning model.” The prompt engine 206 provides the rewritten prompt to the machine-learning module 208, which generates an output image.

FIG. 20F illustrates an example user interface 2050 that includes the output image 2051 generated by the selected machine-learning model. The cats are added and sized in a realistic manner (e.g., the size of the cats is realistic, based on the size of the dog that was removed). The user interface 2050 includes an option for providing a subsequent text prompt in the text field 2052, an option to regenerate the output image 2051 by selecting the regenerate button 2053, and a checkmark 2054. Selecting the checkmark 2054 causes the user interface module 202 to provide different options for modifying the output image 2051.

Responsive to the user selecting the checkmark 2054, FIG. 20G illustrates an example user interface 2060 that includes different options for editing the output image 2061. In some embodiments, the default setting for editing is to provide a tool for cropping the output image 2061, as indicated with the rectangle 2062. Other options are available, such as adding a caption, highlighting a portion of the output image 2061 with a thin line, highlighting a portion of the output image 2061 with a thicker line, erasing a portion of the output image 2061, etc.

The segmenter 204 segments initial images. In some embodiments where a user selects one or more objects or a region in an initial image, the segmenter 204 generates a user-selected mask. In some embodiments, the segmenter 204 generates a segmentation mask that identifies object pixels or region pixels associated with the one or more objects or a region based on segmenting the one or more objects or the region.

The segmenter 204 may segment the one or more objects in the initial image automatically or in response to user input. For example, the segmenter 204 may automatically segment different objects and/or regions in an initial image to create a segmentation mask. In another example, the user interface receives user input identifying an object to be modified, removed, and/or replaced and the segmenter 204 segments the object in response to the object being selected to create a user-selected mask. Segmentation refers to determining pixels of the image that belong to a particular object. In some embodiments, the segmenter 204 generates a segmentation map that associates an identity with each pixel in the initial image as belonging to particular objects or portions thereof (e.g., the face, the body, an object, etc.).

The segmenter 204 may perform the segmentation by detecting objects in an initial image. The object may be a person, an animal, a car, a building, etc. A person may be a subject of the initial image or is not the subject of the initial image (e.g., a bystander captured in the initial image). A bystander may include people walking, running, riding a bicycle, standing behind the subject, or otherwise within the initial image. In different examples, a bystander may be in the foreground (e.g., a person crossing in front of the camera), at the same depth as the subject (e.g., a person standing to the side of the subject), or in the background. In some examples, there may be more than one bystander in the initial image. The bystander may be a human in an arbitrary pose (e.g., standing, sitting, crouching, lying down, jumping, etc.). The bystander may face the camera, may be at an angle to the camera, or may face away from the camera.

The segmenter 204 may detect types of objects by performing object recognition, comparing the objects to object priors of people, vehicles, buildings, etc. to identify expected shapes of objects to determine whether pixels are associated with a selected object or a background.

In some embodiments, the segmenter 204 generates a segmentation mask or a user-selected mask based on the segmentation that indicates the pixels that are to be modified. The segmentation mask or the user-selected mask is used by a machine-learning model to determine the pixels in an initial image that are to be modified based on a rewritten prompt. In some embodiments, the segmentation mask or a user-selected mask corresponds to the segmentation such that the mask identifies a selected object or a selected region. In some embodiments where the original prompt provided by the user includes a request to replace the object, the segmenter 204 generates a segmentation mask that corresponds to a bounding box with x, y coordinates and a scale. The bounding box may be a minimum bounding box that is defined as a smallest rectangle that captures all the pixels associated with the object.

In some embodiments, the segmenter 204 generates a depth map for the initial image. A depth map is a representation of the distance or depth information for each pixel in the initial image. The depth map may be a two-dimensional array where each pixel contains a value that represents the distance from the camera (e.g., camera 243 if the computing device 200 captured the initial image) to a corresponding point in the scene. The depth map provides a continuous representation of the depth information of the scene captured in the initial image. The depth map may be generated using a depth sensor (if available in the initial image as metadata generated during image capture or by deriving depth from pixel values using depth-estimation techniques).

The segmenter 204 may generate a user-selected mask or a segmentation mask based on generating superpixels for the image and matching superpixel centroids to depth map values to cluster detections based on depth. More specifically, depth values in a masked area may be used to determine a depth range and superpixels may be identified that fall within the depth range. Another technique for generating the user-selected mask or the segmentation mask includes weighing depth values based on how close the depth values are to the user-selected mask or the segmentation mask where weights were represented by a distance transform map.

In some embodiments, the segmenter 204 generates a preserving mask that identifies pixels that are to be preserved in the initial image. In some embodiments, the preserving mask is generated for pixels corresponding to a part of a subject, such as face, hands, the whole body, etc.

In some embodiments, the segmenter 204 may specify a circuit configuration (e.g., for a programmable processor, for a field programmable gate array (FPGA), etc.) enabling processor 235 to apply a machine-learning model. In some embodiments, the segmenter 204 may include software instructions, hardware instructions, or a combination. In some embodiments, the segmenter 204 may offer an application programming interface (API) that can be used by the operating system 262 and/or other applications 264 to invoke the segmenter 204 (e.g., to apply the machine-learning model to application data 266 to output the mask).

The segmenter 204 uses training data to generate a trained machine-learning model. For example, training data for generating segmentation masks may include pairs of initial images with one or more objects or a region and output images with one or more segmentation masks. Training data for generating user-selected masks may include pairs of initial images with user-selected objects or regions and output images with one or more user-selected masks. Training data for generating preserving masks may include pairs of initial images with one or more subjects and output images with one or more preserving masks.

Training data may be obtained from any source (e.g., a data repository specifically marked for training, data for which permission is provided for use as training data for machine learning, etc.). In some embodiments, the training may occur on the media server 101 that provides the training data directly to the user device 115, the training occurs locally on the user device 115, or a combination of both.

In some embodiments, the segmenter 204 uses weights that are taken from another application and are unedited/transferred. For example, in these embodiments, the trained model may be generated (e.g., on a different device) and be provided as part of the segmenter 204. In various embodiments, the trained model may be provided as a data file that includes a model structure or form (e.g., that defines a number and type of neural network nodes, connectivity between nodes and organization of the nodes into a plurality of layers), and associated weights. The segmenter 204 may read the data file for the trained model and implement neural networks with node connectivity, layers, and weights based on the model structure or form specified in the trained model.

The trained machine-learning model may include one or more model forms or structures. For example, model forms or structures can include any type of neural-network, such as a linear network, a deep-learning neural network that implements a plurality of layers (e.g., “hidden layers” between an input layer and an output layer, with each layer being a linear network), a convolutional neural network (e.g., a network that splits or partitions input data into multiple parts or tiles, processes each tile separately using one or more neural-network layers, and aggregates the results from the processing of each tile), a sequence-to-sequence neural network (e.g., a network that receives as input sequential data, such as words in a sentence, frames in a video, etc. and produces as output a result sequence), etc.

The model form or structure may specify connectivity between various nodes and organization of nodes into layers. For example, nodes of a first layer (e.g., an input layer) may receive data as input data or application data. Such data can include, for example, one or more pixels per node (e.g., when the trained model is used for analysis, e.g., of an initial image). Subsequent intermediate layers may receive as input, output of nodes of a previous layer per the connectivity specified in the model form or structure. These layers may also be referred to as hidden layers. For example, a first layer may output a segmentation between a foreground and a background. A final layer (e.g., output layer) produces an output of the machine-learning model. For example, the output layer may receive the segmentation of the initial image into a foreground and a background and output whether a pixel is part of a mask or not. In some embodiments, the model form or structure also specifies a number and/or type of nodes in each layer.

In different embodiments, the trained model can include one or more models. One or more of the models may include a plurality of nodes, arranged into layers per the model structure or form. In some embodiments, the nodes may be computational nodes with no memory (e.g., configured to process one unit of input to produce one unit of output). Computation performed by a node may include, for example, multiplying each of a plurality of node inputs by a weight, obtaining a weighted sum, and adjusting the weighted sum with a bias or intercept value to produce the node output. In some embodiments, the computation performed by a node may also include applying a step/activation function to the adjusted weighted sum. In some embodiments, the step/activation function may be a nonlinear function. In various embodiments, such computation may include operations such as matrix multiplication. In some embodiments, computations by the plurality of nodes may be performed in parallel, e.g., using multiple processors cores of a multicore processor, using individual processing units of a graphics processing unit (GPU), or special-purpose neural circuitry. In some embodiments, nodes may include memory (e.g., may be able to store and use one or more earlier inputs in processing a subsequent input). For example, nodes with memory may include long short-term memory (LSTM) nodes. LSTM nodes may use the memory to maintain “state” that permits the node to act like a finite state machine (FSM).

In some embodiments, the trained model may include embeddings or weights for individual nodes. For example, a model may be initiated as a plurality of nodes organized into layers as specified by the model form or structure. At initialization, a respective weight may be applied to a connection between each pair of nodes that are connected per the model form, e.g., nodes in successive layers of the neural network. For example, the respective weights may be randomly assigned, or initialized to default values. The model may then be trained (e.g., using training data) to produce a result.

Training may include applying supervised learning techniques. In supervised learning, the training data can include a plurality of inputs (e.g., initial images, user input, etc.) and a corresponding ground truth output for each input (e.g., a ground truth user-selected mask that correctly identifies pixels corresponding to a selected object, a ground truth segmentation mask that correctly identifies pixels corresponding to objects or regions, or a ground truth preserving mask that correctly identifies a portion of the subject, such as the subject's face, in each image). Based on a comparison of the output of the model with the ground truth output, values of the weights are automatically adjusted (e.g., in a manner that increases a probability that the model produces the ground truth output for the image).

In various embodiments, a trained model includes a set of weights, or embeddings, corresponding to the model structure. In some embodiments, the trained model may include a set of weights that are fixed, e.g., downloaded from a server that provides the weights. In various embodiments, a trained model includes a set of weights, or embeddings, corresponding to the model structure. In embodiments where data is omitted, the segmenter 204 may generate a trained model that is based on prior training (e.g., by a developer of the segmenter 204, by a third-party, etc.).

In some embodiments, the trained machine-learning model receives an initial image with one or more selected objects. In some embodiments, the trained machine-learning model outputs one or more user-selected masks that identify object pixels associated with the one or more objects in the initial image. In some embodiments, the trained machine-learning model receives an initial image and outputs one or more segmentation masks. In some embodiments, if the initial image includes one or more human subjects, the trained machine-learning model generates one or more preservation masks that correspond to the one or more human subjects. For example, the one or more preservation masks may be for faces of the one or more subjects.

The prompt engine 206 receives an initial image and an original prompt from the user interface module 202. In some embodiments, the prompt engine 206 also receives user input from the user interface module 202, such as selection of one or more objects and/or a region.

The prompt engine 206 (e.g., generated with an LLM that is part of the prompt engine 206, a base LLM that is part of the prompt engine 206 and a backend LLM, another text generation model, etc.) generates a rewritten prompt based on the initial image, the original prompt, and user input if applicable. The rewritten prompt is designed to make the request from the user for an output image compatible with machine learning image generation models (e.g., include generation context, ensure that the prompt is within model limitations, include restrictions on generation, etc.). In some embodiments, the prompt engine 206 adds the name of the selected object and/or region to the rewritten prompt. For example, the prompt engine 206 receives an initial image of an eagle and an original prompt that states: “Make it a cartoon look” and outputs a rewritten prompt that states: “change the eagle in the image to a cartoon eagle.”

In some embodiments, the description of the selected object may be specific. For example, the prompt engine 206 receives an original prompt that states: “ice” along with an initial image of a seal in water and outputs a rewritten prompt that states: “replace the background to water surface covered in broken ice.” In some embodiments, the rewritten prompt may include commands for multiple images. For example, the prompt engine 206 receives an original prompt of a man on a bicycle that is on a high sloped road that states “cliff and ominous clouds.” The prompt engine 206 rewrites the prompt to “replace the background to the cliff of a mountain with a very sharp drop under a sky with ominous clouds.”

In some embodiments, the prompt engine 206 implements a machine-learning model, such as a large language model (LLM) (e.g., text generation LLM, multimodal LLM, etc.) that uses natural language processing (NLP) to provide conversational responses to text queries. In some embodiments, the LLM is stored on the computing device 220 or is stored on a separate server.

In some embodiments, the machine-learning model includes an encoder that generates a representation of the original prompt, the initial image, and the user input. For example, the encoder receives an initial image of the Golden Gate Bridge and an original prompt that states “icy” with user input that selects the water region in the initial image. The machine-learning model also includes a transformer for generating embeddings of the original prompt, the initial image, and the user input a self-attention mechanism for aggregating information from the embeddings to generate a rewritten prompt. Continuing with the example above, the transformer outputs a rewritten prompt that states: “generate icy water beneath a bridge on a cold winter day.”

In some embodiments, the prompt engine 206 includes a multilingual LLM that is capable of receiving input in languages other than English and outputs rewritten prompts in the language of an original prompt or a language that is compatible with the image generation machine-learning model.

The prompt engine 206 selects, based on the original prompt and/or the rewritten prompt, a machine-learning model from a set of machine-learning models to generate an output image. In some embodiments, the prompt engine 206 includes a base LLM that is used to select the machine-learning model. In some embodiments, the prompt engine 206 uses the LLM that also generates the rewritten prompt.

In some embodiments, the rewritten prompt includes a command of which machine-learning model to use from the set of machine-learning models. In some embodiments, the set of machine-learning models includes three types of machine-learning models: a structure-preserving machine-learning model, a shape preserving machine-learning model, and a non-structure and non-shape preserving machine-learning model. In some embodiments, the set of machine-learning models includes text-to-image models and image-to-image models. In various embodiments, two, three, four, or any other number of machine-learning models may be utilized.

Different image generation machine-learning models may be implemented using different techniques (e.g., diffusion model, models trained using generative adversarial network methodology, or other types of models). In different embodiments, the different models may have different reliability, different image generation capabilities, different computational costs, etc. and selection of the model may be based on one or more of these model attributes. In some embodiments, the different types of machine-learning models may be trained to output different styles of images. For example, the machine-learning models may be trained to output stickers, avatars, anime images, cartoon images, Americana images, etc.

In some embodiments, the prompt engine 206 selects the structure-preserving machine-learning model for rewritten prompts that request a modification to one or more objects or a region in the initial image while preserving a structure and a shape of the one or more objects or the region. Selecting the machine-learning model can include analyzing and/or parsing the text prompt to determine whether generating the output image requires a structure-preserving modification, a shape preserving modification, or a non-structure and non-shape preserving modification.

A structure-preserving machine-learning model is used for changing the color of an object because the structure-preserving machine-learning model is trained to keep the structure of the object that is modified for the output image. The structure-preserving machine-learning model uses depth control as a parameter during image generation. In some embodiments, a structure-preserving machine-learning model is trained to learn a joint embedding space where feature vectors for input text are closely associated with feature vectors for initial images and images with similar meaning are close to each other in the learned latent space.

A structure-preserving machine-learning model does not satisfy a rewritten prompt if the rewritten prompt requests a modification to one or more objects or a region of the initial image that changes the structure of the one or more objects or the region. For example, if the prompt requests an image of a lizard found in nature to be changed to a cartoon lizard, although the shape of the lizard remains the same, details such as the texture of the lizard are changed.

For rewritten prompts that request a modification to the one or more objects or the region in the initial image while preserving a shape of the one or more objects or the region, the prompt engine 206 selects the shape-preserving machine-learning model. In some embodiments, the shape-preserving machine-learning model makes modifications to a structure of the one or more objects or the region while preserving the shape and not using depth control.

In various embodiments, an LLM may perform a reasoning task to generate the rewritten prompt. For example, the LLM may be provided with a query “The user has provided a prompt that states wavy. The prompt is in the context of an image modification request. The initial image is of a sailboat in calm water in an ocean. There are no other objects in the image. Please rewrite the user prompt based on this information.” In response, the LLM may perform reasoning (e.g., determine that the state “wavy” is frequently associated with water including oceans or lakes that may be traveled on by sailboats and not with sailboats), and thereby, determine that the rewritten prompt is to indicate that the ocean is to be wavy in the output image. In comparison, if the user input text states “sails full,” the LLM may reason that the text corresponds to the sails of the sailboat being fully inflated (e.g., due to the presence of strong winds) and rewrite the prompt as “a sailboat in the ocean having its sails full.” In another example, if the user input text states “topsy-turvy ride,” the LLM may rewrite the prompt as “a sailboat in strong ocean waves, the boat not level with the ocean surface.” The LLM may perform such reasoning tasks based on mapping the user input text (with the additional context) in latent space to generate output text that is responsive to the reasoning task included in the input to the LLM.

A structure-preserving machine-learning model and a shape-preserving machine-learning model do not satisfy a rewritten prompt if the rewritten prompt requests a replacement of the one or more objects or the region of the initial image because the shape and the structure of the one or more objects or the region in the initial image may be modified. For example, if a user requests to replace a glass with a mug, the glass and the mug have different shapes and structures. If a structure-preserving machine-learning model or a shape-preserving machine-learning model is used to generate the output image, the output image may include two mugs that are stacked to resemble the shape of the glass. Conversely, if a non-structure and non-shape preserving machine-learning model is used to generate the output image, the output image includes a mug with a mug shape and structure that is not constrained by the attributes of the glass in the image.

In some embodiments, the prompt engine 206 selects a non-structure and non-shape preserving machine-learning model when the rewritten prompt requests a replacement of the one or more objects or the region in the initial image with one or more new objects or a new region. In some embodiments, prompt engine 206 selects a non-structure and non-shape preserving machine-learning model when the rewritten prompt requests an additional object to be added to the initial image. Selecting the non-structure and non-shape preserving model, which is not conditioned on a depth map, is technically advantageous for tasks like object replacement. This provides the technical effect of freeing the image generation process from the structural constraints of the initial image, enabling the generation of an output image with one or more new objects or a new region in a computationally efficient manner.

In some embodiments, the prompt engine 206 generates rewritten prompts for presets. For example, if a user selects a magical castles preset and the original prompt is “girl in a dress,” the prompt engine 206 may generate the following rewritten prompt: “generate a background with magical castles and a girl in a ball gown using a non-structure preserving and non-shape preserving machine-learning model.”

The machine-learning module 208 trains machine-learning models to generate output images based on rewritten prompts and, in some embodiments, initial images. In some embodiments, the machine-learning module 208 receives a command from the prompt engine 206 to generate the output image based on a machine-learning model selected by the prompt engine 206 along with the initial image, the rewritten prompt, and user input if available. In some embodiments, the machine-learning model is selected from a structure-preserving machine-learning model, a shape-preserving machine-learning model, or a non-structure and non-shape preserving machine-learning model.

The machine-learning module 208 trains and implements a machine-learning model to receive an initial image and a textual request to generate an output image; the segmentation mask or a user-selected mask as input and/or the preserving mask.

A diffusion model generates an output image that satisfies the textual request and that does not include object pixels that are associated with a human subject. In some embodiments, the diffusion model receives an empty mask as input that identifies all the pixels in the initial image as being not associated with a human (regardless of whether the initial image includes a human). As a result of using the empty mask, the machine-learning module 208 generates an output image that does not include human pixels.

In some embodiments where the initial image includes a human subject (either as a selected object or present in the image), the machine-learning model also receives the preserving mask from the segmenter 204. The preserving mask is used to prevent modification by the machine-learning model to the human subject during the generation of the output image.

In some embodiments, the machine-learning model is a diffusion model, and the machine-learning module 208 trains the diffusion model with a two-step process to generate an output image. First, the diffusion model is trained to perform a forward diffusion process on an initial image where Gaussian noise with variance is added to obtain a noisy image. The Gaussian noise with variance is added to obtain progressively noisier images until the final noisy image is achieved. Second, the diffusion model is trained to perform a reverse diffusion process that uses a convolutional neural network (CNN) to transform the final noisy image into meaningful output (e.g., output image).

The machine-learning module 208 trains the diffusion model to perform forward diffusion by using training data that includes initial images. The machine-learning module 208 converts the initial images to tensors. A tensor is an array of bytes with any number of dimensions. The tensor may be described as having an arbitrary shape since the tensor may have any number of dimensions. The machine-learning module 208 parses the bytes in the tensors to convert them into pixel data for the red green blue (RGB) color channels.

The machine-learning module 208 may sample noise to match the shape (dimensions) of the initial images. The machine-learning module 208 may sample random diffusion times and use these to generate the noise and signal rates according to a diffusion schedule. The machine-learning module 208 applies weightings to the initial images to generate the noisy images. In some embodiments where the diffusion model is used to generate an output image from text, each forward diffusion step predicts the noise from a noisy image and text embedding generated from the text.

The machine-learning module 208 calculates the loss (e.g., a mean absolute error) between the predicted noise and noise from a ground truth image and takes a gradient step against this loss function. After the gradient step, the neural network weights of the diffusion model (under training) are updated to a weighted average of the existing weights and the trained neural network weights.

The machine-learning module 208 may train the diffusion model to perform reverse diffusion and denoise a noisy image so that it satisfies a textual request by instructing the neural network to predict the noise and then undo the noising operation using noise rates and signal rates. The diffusion model includes a CNN, which includes convolutional layers where the output of one layer serves as input to a subsequent layer. The convolutional layers include downsampling blocks, where the initial images are compressed spatially but expanded channel wise, and upsampling blocks where representations are expended spatially while the number of channels is reduced.

The machine-learning module 208 provides a noise variance and the noisy image as described by tensors as input to a first convolutional layer in the CNN to increase the number of channels. The noise variance and the noisy image are concatenated across channels. In some embodiments, the machine-learning module 208 includes skip connections between output from convolutional layers that perform downsampling and convolutional layers that perform upsampling for equivalent spatially shaped layers in the network. A final convolutional layer may reduce the number of channels to the three RGB channels.

During training for the reverse diffusion process, the machine-learning module 208 predicts noise in order to remove the noise from the noisy image to achieve the initial image. The machine-learning module 208 performs the prediction over a number of steps and the number of steps may be different from the number of steps used during training for the forward diffusion process.

### Structure Preserving Machine-Learning Model

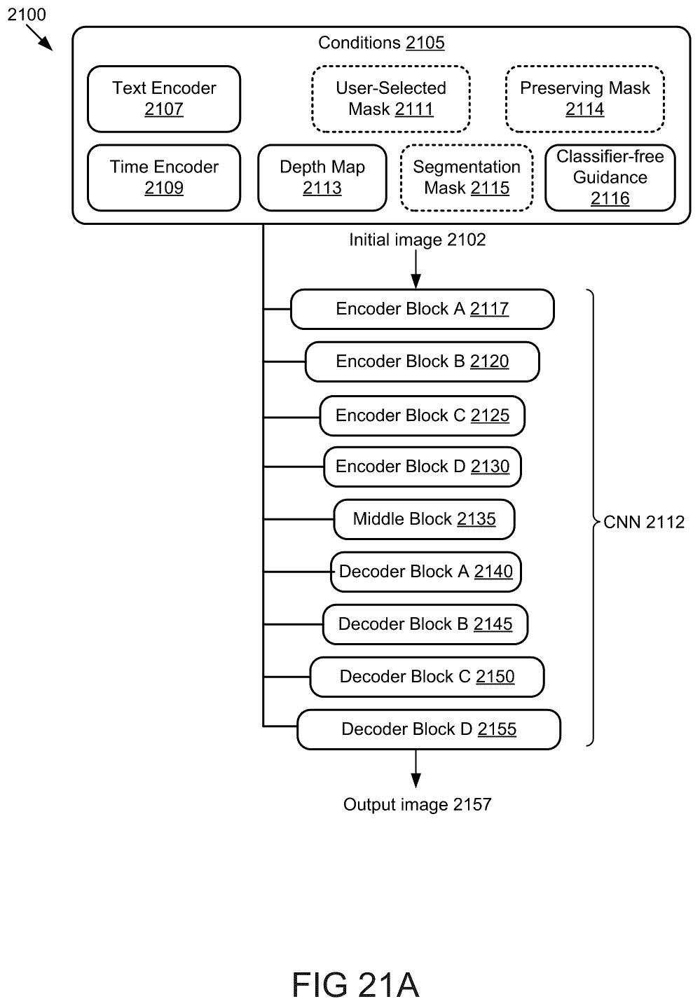

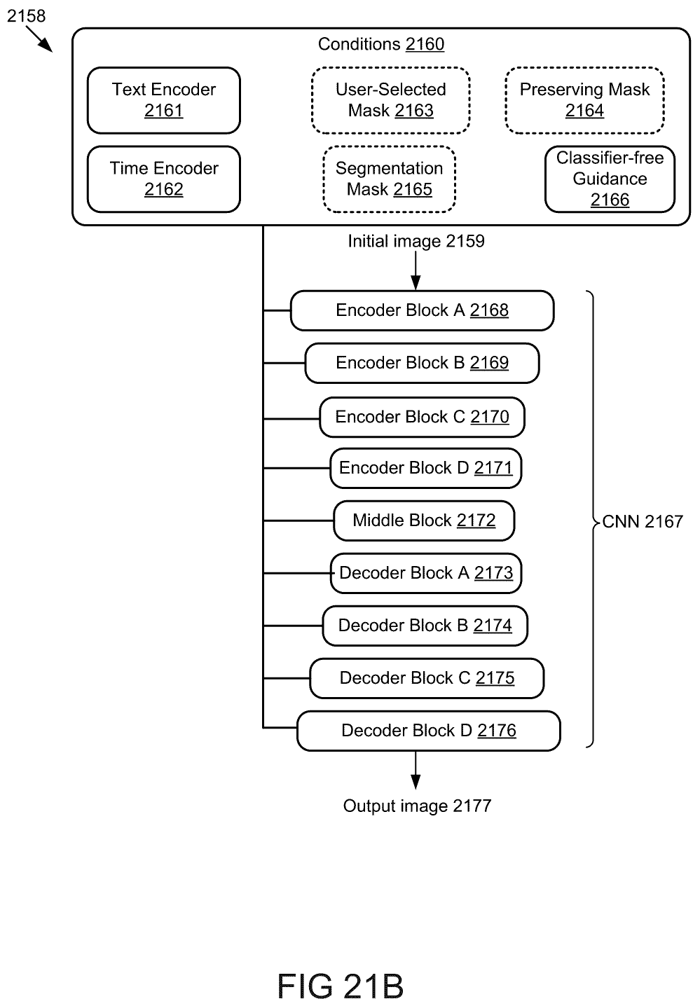

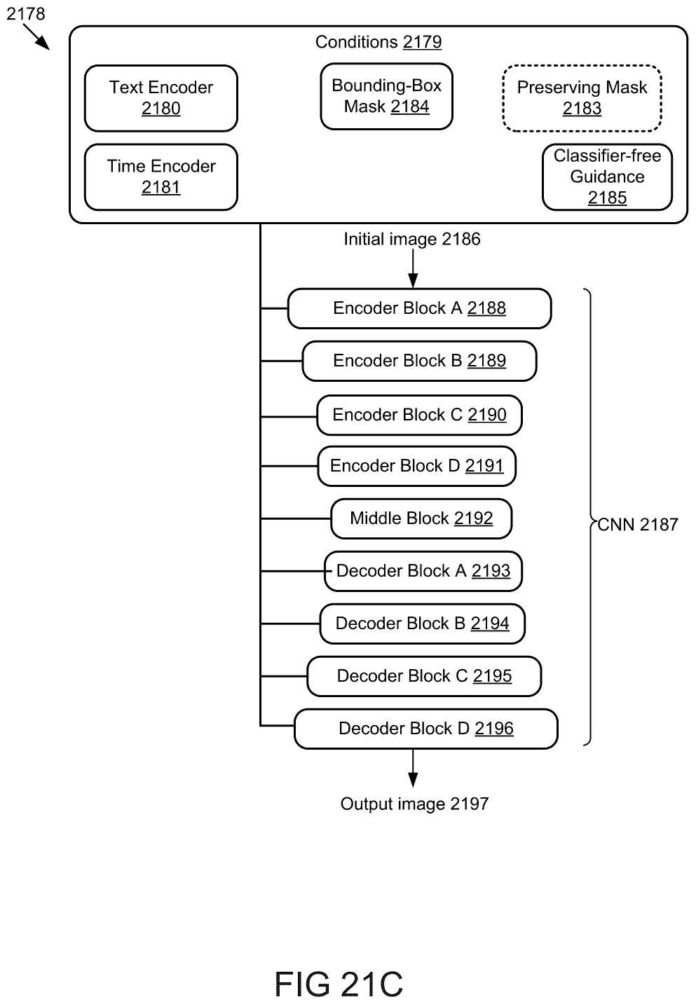

FIG. 21A illustrates an architecture of an example structure preserving machine-learning model, according to some embodiments described herein. In some embodiments, the structure preserving machine-learning model is a diffusion model 2100. The diffusion model 2100 may be a part of the media application 103 of FIG. 1 and/or the machine-learning model 208 of FIG. 2.

The diffusion model 2100 is trained using training data that includes initial images 2102 and conditions 2105. In some embodiments, the training data includes ground truth output images, such as output images that satisfy textual requests and that have modifications to one or more objects or a region that include a same structure and a same shape. For example, the initial image may include an object with a first color (e.g., a green trampoline) and the ground truth image includes the object with a second color (e.g., a purple trampoline). In some embodiments, training data further includes pairs of ground truth images and corresponding images with randomly masked portions of the ground truth images.

The conditions 2105 include a text encoder 2107, a time encoder 2109, an optional user-selected mask 2111, a depth map 2113, an optional preserving mask 2114, an optional segmentation mask 2115, and classifier-free guidance 2116. The text encoder 2107 encodes a textual request (i.e., a textual condition) by converting the text to tokens for a vector that represents the textual request in vector space (embedding space). The time encoder 2109 encodes diffusion timestamps using positional encoding.

The user-selected mask 2111 identifies object pixels associated with one or more objects or a region that are selected by a user in the initial image. During inference (i.e., during generation of an output image), the user-selected mask 2111 identifies the area to be modified in the output image. The user-selected mask 2111 may identify object pixels that are associated with one or more selected objects.

The depth map 2113 identifies a depth of one or more of the image pixels in the initial image. The depth map 2113 is provided as input to the CNN 2112 to preserve the relative depth of various objects in the initial image in the output image. For example, if a selected image includes a door with a handle, the depth map 2113 is used to preserve the structure of the door and maintain the handle in the output image. The depth map 2113 is used for requests where a user wants the output image to maintain photorealism. The depth map 2113 is also advantageous for modifying the texture of a selected area without recalculating an entire output image, thereby improving a computational efficiency of the structure preserving machine-learning model.

The preserving mask 2114 identifies pixels that correspond to human subjects in the initial image and that are to be preserved during generation of the output image 2157. For example, the preserving mask may include a human subject's hair if the user indicates that the hair is to remain the same (or more generally, does not specify changes to the hair in conditions 2105), the human subject's fingers, a subject's entire body where the subject is a pet to prevent the pet from being overly modified, etc. In some embodiments where the output image modifies the clothing of the human subject, the preserving mask excludes pixels of the clothing of the human subject and instead includes the remaining pixels associated with the human subject to prevent modification to the human subject by the diffusion model 2100. In some embodiments, multiple different generative machine learning diffusion models may be trained and available for use in image generation (e.g., shape-preserving model, structure-preserving model, etc.). In some embodiments, instead of using a preserving mask 2114, the conditions 2105 may include an empty mask that identifies all pixels in the initial image 2102 as not being associated with a human.

The segmentation mask 2115 identifies the one or more objects or one or more regions in the initial image 2102. In some embodiments, the segmentation mask 2115 is used if the user-selected mask 2111 is not used. In some embodiments, the segmentation mask 2115 is used in addition to using the user-selected mask 2111 to improve identification of the user-selected mask 2111.

In some embodiments, the depth in the output image is controlled with classifier-free guidance 2116. Classifier guidance controls the categories generated by a classification model. Classifier-free guidance 2116 trains the diffusion model 2100 on conditions with conditioning dropout, which is when some percentage of the time, the conditions are removed. In some embodiments, removed conditions are replaced with a special input value that represents an absence of conditioning information. A higher conditioning dropout value preserves a structure of the one or more objects in the initial image more than a lower conditioning dropout value. One disadvantage of the higher conditioning dropout value is that the increased structure may come at a cost of decreased diversity of output images.

The initial image(s) 2102 are provided as input to a first layer of a CNN 2112 and the conditions 2105 are provided as input to each block within the CNN 2112. The CNN 2112 includes encoder blocks 2117, 2120, 2125, 2130; a middle block 2135; and skip-connected decoder blocks 2140, 2145, 2150, 2155. In some embodiments, the model is a diffusion model 2100 and contains 25 blocks where 8 blocks are down-sampling or up-sampling convolutional layers. While FIG. 21A shows four encoder blocks and four decoder blocks, in various embodiments, fewer or greater numbers of encoder blocks and/or decoder blocks can be used (and the number of encoder blocks and the number of decoder blocks may be different).

The denoising process may occur in pixel space or in latent space of the diffusion model 2100. In some embodiments, during training, the machine-learning module 208 performs preprocessing on initial images 2102 to convert the initial images 2102 from pixel-space images to latent space (e.g., a vector representation of the image in high-dimensional vector space). The machine-learning module 208 performs training by converting one or more of the conditions 2105 from an input size to a feature space vector that matches the size of the CNN 2112.

The machine-learning module 208 trains the diffusion model 2100 to receive an initial image 2102 and progressively add noise to the initial image 2102 with each iteration of the diffusion model 2100 to produce a noisy image. Given a set of conditions 2105 including time generated by the time encoder 2109, textual requests encoded by the text encoder 2107, and other task-specific conditions (e.g., the user-selected mask 2111, the depth map 2113, the preserving mask 2114, the segmentation mask 2115, and classifier-free guidance 2116), image diffusion models are trained to predict the noise added to the noisy image. The machine-learning module 208 trains the diffusion model 2100 to generate a plurality of output images (via a denoising process) that satisfy the textual requests and that do not include human pixels by progressively removing the noise. In some embodiments, the denoising during training includes about 10,000 optimization steps to minimize loss between generated output images and ground truth output images.

In some embodiments, the machine-learning module 208 trains the diffusion model using three different versions of varying amounts of textual requests and depth values. For example, the machine-learning module 208 may run a first version of the diffusion model with no textual requests and no depth values, run a second version of the diffusion model with the textual requests and no depth values, and run a third version of the diffusion model with the textual requests and the depth values. Training each version of the diffusion model may include multiple iterations.

Once the diffusion model is trained, if the diffusion model is a text-to-image model, the trained diffusion model receives a textual request to generate an output image. If the diffusion model is an image-to-image model, the trained diffusion model receives an initial image; a textual request to generate an output image; a corresponding depth map; and the user-selected mask, the preserving mask, and/or the segmentation mask. The diffusion model performs a diffusion process on the initial image to generate a noisy image based on the initial image. In some embodiments, the diffusion model performs an inverse diffusion process, such as a DDIM inversion, to generate an output image from the noisy image, where the output image is generated in accordance with conditions 2105. The diffusion model performs reverse diffusion by predicting noise added to the noisy image and generating an output image that satisfies the textual request.

### Shape Preserving Machine-Learning Model

FIG. 21B illustrates an architecture of an example shape preserving machine-learning model, according to some embodiments described herein. In some embodiments, the shape preserving machine-learning model is a diffusion model 2158. The diffusion model 2158 may be a part of the media application 103 of FIG. 1 and/or the machine-learning model 208 of FIG. 2.

The diffusion model 2158 is trained using training data that includes initial images 2159 and conditions 2160. In some embodiments, the training data includes ground truth output images, such as output images that satisfy textual requests and that have modifications to one or more objects or a region that include a same shape. For example, the initial image may include an object with a first texture (e.g., a realistic cat) and the ground truth includes the object with a second texture (e.g., a cartoon version of the cat). In some embodiments, training data further includes pairs of ground truth images and corresponding images with randomly masked portions of the ground truth images.

In some embodiments, the architecture for the diffusion model 2158 is similar to the structure preserving machine-learning model, except that the shape preserving machine-learning model does not include a depth map as input. The conditions 2160 include a text encoder 2161, a time encoder 2162, an optional user-selected mask 2163, an optional preserving mask 2164, an optional segmentation mask 2165, and classifier-free guidance 2166. Because these conditions 2160 are similar to the conditions 2105 described with reference to FIG. 21A, further details will not be repeated here.

The initial image(s) 2159 are provided as input to a first layer of a CNN 2167 and the conditions 2160 are provided as input to each block within the CNN 2167. The CNN 2167 includes encoder blocks 2168, 2169, 2170, 2171; a middle block 2172; and skip-connected decoder blocks 2173, 2174, 2175, 2176. Because the CNN 2167 is similar to the CNN 2112 described with reference to FIG. 21A, further details will not be repeated here. The diffusion model 2158 is trained to generate an output image 2177 that satisfies the rewritten prompt.

### Non-Structure and Non-Shape Preserving Machine-Learning Model

FIG. 21C illustrates an architecture of an example non-structure and non-shape preserving machine-learning model, according to some embodiments described herein. In some embodiments, the non-structure and non-shape preserving machine-learning model is a diffusion model 2178. The diffusion model 2178 may be a part of the media application 103 of FIG. 1 and/or the machine-learning model 208 of FIG. 2.

The diffusion model 2178 is trained using training data that includes initial images 2186 and conditions 2179. In some embodiments, the training data includes ground truth output images, such as output images that satisfy textual requests and that have modifications to one or more objects or a region that do not include a same structure or a same shape. For example, the initial image may include a first object (e.g., a dog) and the ground truth image includes the object with a second object (e.g., a cat). In some embodiments, the training data further includes an initial image and the ground truth image includes an object that was not present in the initial image. In some embodiments, training data further includes pairs of ground truth images and corresponding images with randomly masked portions of the ground truth images.

In some embodiments, the architecture for the diffusion model 2178 is similar to the structure preserving machine-learning model, except that the non-structure and non-shape preserving machine-learning model does not include a depth map, a user-selected mask, or a segmentation mask as conditions 2179. In addition, for examples where a first object is being replaced with a second object, the conditions include a bounding-box mask 2184 that indicates a location where the second object is to be located. The conditions 2179 additionally include a text encoder 2180, a time encoder 2181, an optional preserving mask 2183, and classifier-free guidance 2185. Because these conditions 2179 are similar to the conditions 2105 described with reference to FIG. 21A, further details will not be repeated here.

The initial image(s) 2186 are provided as input to a first layer of a CNN 2187 and the conditions 2179 are provided as input to each block within the CNN 2187. The CNN 2187 includes encoder blocks 2188, 2189, 2190, 2191; a middle block 2192; and skip-connected decoder blocks 2193, 2194, 2195, 2196. Because the CNN 2187 is similar to the CNN 2112 described with reference to FIG. 21A, further details will not be repeated here. The diffusion model 2158 is trained to generate an output image 2197 that satisfies the rewritten prompt.

### Example Method

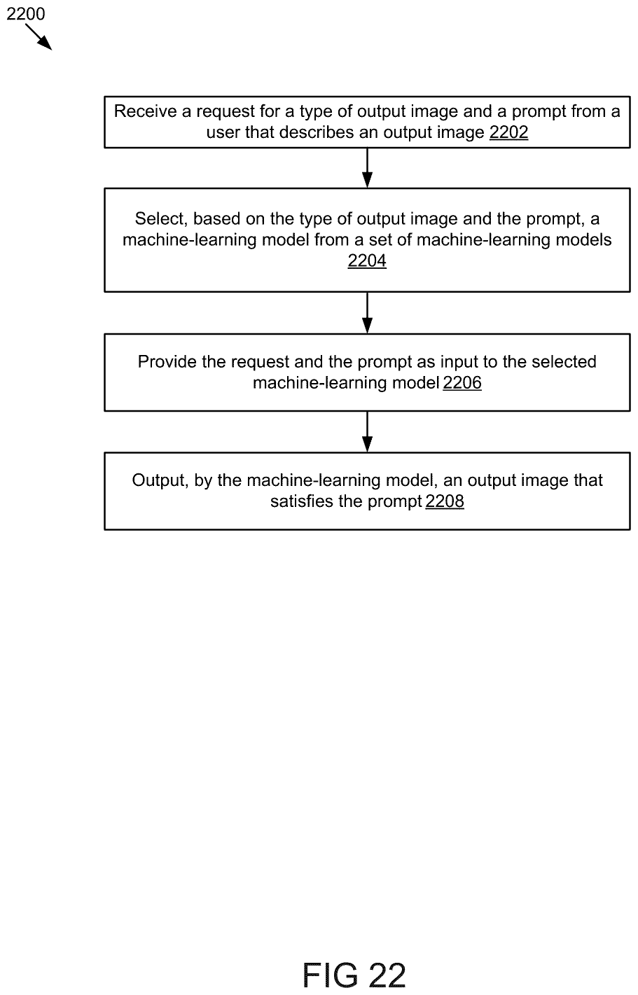

FIG. 22 illustrates an example method 2200 to generate an output image based on a rewritten prompt. The method 2200 may be performed by the computing device 200 in FIG. 2. In some embodiments, the method 2200 is performed by the user device 115, the media server 101, or in part on the user device 115 and in part on the media server 101.

The method 2200 of FIG. 22 may begin at block 2202. At block 2202, a request for a type of output image and a prompt for a user that describes the output image are received. The prompt may be a textual prompt that includes only text or an initial prompt that includes text, images, etc. Block 2202 may be followed by block 2204.

At block 2204, a machine-learning model is selected from a set of machine-learning models based on a type of output image and the prompt. Block 2204 may be followed by block 2206.

At block 2206, the request and the prompt are provided as input to the selected machine-learning model.

At block 2208, the machine-learning model outputs an output image that satisfies the prompt.

In some embodiments, the method 2200 further includes generating a rewritten prompt based on the request for the type of output image and the prompt, where selecting the machine-learning model based on the type of output image and the prompt is further based on the rewritten prompt. In some embodiments, the type of output image includes a sticker, the selected machine-learning model is trained to output the sticker, and the output image is the sticker. In some embodiments, the method 2200 further includes receiving a subsequent prompt that describes an action to be performed as an animation by the sticker and generating, by the selected machine-learning model, the animation based on the subsequent prompt. In some embodiments, the method 2200 further includes receiving user input that selects one or more objects from the output image and a subsequent request to generate a sticker from the output image, segmenting the one or more selected objects from a background, and generating the sticker, wherein the sticker includes a transparent version of the background. In some embodiments, the type of output image in the request is for a sticker, receiving the request for the type of output image and the prompt from the user that describes the output image further includes an initial image, and generating, by the selected machine-learning model, the output image that satisfies the request and the prompt includes generating the sticker based on the initial image, the prompt, and the request to generate the sticker.

In some embodiments, the method 2200 further includes receiving an initial image of the user and a request to generate an avatar, where generating, by the selected machine-learning model, the output image that satisfies the prompt includes generating the avatar based on the initial image, the prompt, and the request to generate the avatar. In some embodiments, the method 2200 further includes generating a user interface that includes a text field and an option to add a name of the avatar to the text field and an option to add the avatar to a text chat by writing the name of the avatar in the text chat. In some embodiments, the method 2200 further includes receiving a subsequent prompt that includes a request to generate a subsequent output image that includes the avatar performing an action and generating, with the selected machine-learning model, the subsequent output image that satisfies the subsequent prompt by illustrating the avatar performing the action. In some embodiments, the method 2200 further includes providing the avatar to a messaging application associated with the user; receiving a subsequent prompt from the messaging application associated with the user that includes a request to generate a video that includes the avatar performing an action; generating, with the selected machine-learning model, an output video; and providing the output video to the messaging application. In some embodiments, receiving a subsequent prompt that includes a request to generate a subsequent output image of the avatar in one or more pieces of clothing and generating, with the selected machine-learning model, the subsequent output image that satisfies the subsequent prompt by illustrating the avatar in the one or more pieces of clothing. In some embodiments, the method 2200 further includes providing a user interface to the user that includes an icon of the avatar and a text field, receiving a selection of the icon of the avatar, displaying the icon of the avatar in the text field, receiving a subsequent prompt via the text field, and generating a subsequent output image that satisfies the subsequent prompt and that includes the avatar based on the text field including the icon of the avatar in the text field.

In some embodiments, the method 2200 further includes providing subsequent prompts as inputs to the selected machine-learning model one or more times as the user provides subsequent inputs refining the prompt, wherein the subsequent inputs include one or more new words, replacement of words of the prompt, or combinations thereof and outputting subsequent output images responsive to receiving the subsequent prompts. In some embodiments, the set of machine-learning models includes a structure-preserving machine-learning model, a shape-preserving machine-learning model, and a non-structure and non-shape preserving machine-learning model.

In some embodiments, one or more of blocks 2202-2206 may be performed any number of times. For example, for various illustrative user interfaces shown in FIGS. 3A-3C, 4A-4C, 5A-5H, 7A-7F, 8A-8C, 9A-9C, 10A-10C, 11A-11E, 12A-12G, 13A-13J, 14A-14D, 15A-15C, 16A-16D, 17A-17C, 18A-18D, 19A-19G, and 20A-20G may be supported by one or more executions of various blocks 902-912. For example, blocks 2202 to 2208 may be performed to generate the image of FIG. 5C (without any user initial image). As the user continues to refine the input text prompt, the generated image may be set as the initial image and blocks 2202-2208 may be performed multiple times to generate successive new images that are responsive to the prompt refinement, such as the image of FIG. 5H.

In various embodiments, the original prompt from the user and/or the rewritten prompt from the LLM may be subject to one or more filters to ensure that the generated output image is compliant with applicable rules and standards. For example, the filters may detect textual requests that prevent certain modifications to the image (e.g., addition of a prohibited category of object, changes to objects in the image that meet certain criteria, etc.). In response to such detection, the user is provided with guidance regarding the types of textual requests that are impermissible. Additionally, the user may be provided guidance regarding structuring the textual request to specify their requirement with respect to the output image.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

In the above description, for purposes of explanation, numerous specific details are set forth in order to provide a thorough understanding of the specification. The disclosure can be practiced without these specific details. In some instances, structures and devices are shown in block diagram form in order to avoid obscuring the description. For example, the embodiments can be described above primarily with reference to user interfaces and particular hardware. However, the embodiments can apply to any type of computing device that can receive data and commands, and any peripheral devices providing services.

Reference in the specification to “some embodiments” or “some instances” means that a particular feature, structure, or characteristic described in connection with the embodiments or instances can be included in at least one implementation of the description. The appearances of the phrase “in some embodiments” in various places in the specification are not necessarily all referring to the same embodiments.

Some portions of the detailed descriptions above are presented in terms of algorithms and symbolic representations of operations on data bits within a computer memory. These algorithmic descriptions and representations are used by those of ordinary skill in the data processing arts to most effectively convey the substance of their work to others. An algorithm is here, and generally, conceived to be a self-consistent sequence of steps leading to a desired result. The steps are those requiring physical manipulations of physical quantities. Usually, though not necessarily, these quantities take the form of electrical or magnetic data capable of being stored, transferred, combined, compared, and otherwise manipulated. It has proven convenient at times, principally for reasons of common usage, to refer to these data as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The embodiments of the specification can also relate to a processor for performing one or more steps of the methods described above. The processor may be a special-purpose processor selectively activated or reconfigured by a computer program stored in the computer. Such a computer program may be stored in a non-transitory computer-readable storage medium, including, but not limited to, any type of disk including optical disks, ROMs, CD-ROMs, magnetic disks, RAMS, EPROMs, EEPROMs, magnetic or optical cards, flash memories including USB keys with non-volatile memory, or any type of media suitable for storing electronic instructions, each coupled to a computer system bus.

The specification can take the form of some entirely hardware embodiments, some entirely software embodiments or some embodiments containing both hardware and software elements. In some embodiments, the specification is implemented in software, which includes, but is not limited to, firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

What is claimed is:

1. A computer-implemented method comprising:
receiving a request for a type of output image and a prompt from a user that describes an output image;
selecting, based on the type of output image and the prompt, a machine-learning model from a set of machine-learning models;
providing the request and the prompt as input to the selected machine-learning model; and
generating, by the selected machine-learning model, the output image that satisfies the request and the prompt.

2. The method of claim 1, further comprising:
generating a rewritten prompt based on the request for the type of output image and the prompt;
wherein selecting the machine-learning model based on the type of output image and the prompt is further based on the rewritten prompt.

3. The method of claim 1, wherein:
the type of output image includes a sticker;
the selected machine-learning model is trained to output the sticker; and
the output image is the sticker.

4. The method of claim 3, further comprising:
receiving a subsequent prompt that describes an action to be performed as an animation by the sticker; and
generating, by the selected machine-learning model, the animation based on the subsequent prompt.

5. The method of claim 1, further comprising:
receiving user input that selects one or more objects from the output image and a subsequent request to generate a sticker from the output image;
segmenting the one or more selected objects from a background; and
generating the sticker, wherein the sticker includes a transparent version of the background.

6. The method of claim 1, wherein:
the request for the type of output image is a request to generate a sticker;
the method further comprises receiving an initial image; and
generating, by the selecting machine-learning model, the output image that satisfies the request and the prompt includes generating the sticker based on the initial image, the prompt, and the request to generate the sticker.

7. The method of claim 1, further comprising:
receiving an initial image of the user and a request to generate an avatar;
wherein generating, by the selected machine-learning model, the output image that satisfies the prompt includes generating the avatar based on the initial image, the prompt, and the request to generate the avatar.

8. The method of claim 7, further comprising:
generating a user interface that includes a text field and an option to add a name of the avatar to the text field and an option to add the avatar to a text chat by writing the name of the avatar in the text chat.

9. The method of claim 7, further comprising:
receiving a subsequent prompt that includes a request to generate a subsequent output image that includes the avatar performing an action; and
generating, with the selected machine-learning model, the subsequent output image that satisfies the subsequent prompt by illustrating the avatar performing the action.

10. The method of claim 7, further comprising:
providing the avatar to a messaging application associated with the user;
receiving a subsequent prompt from the messaging application associated with the user that includes a request to generate a video that includes the avatar performing an action;
generating, with the selected machine-learning model, an output video that satisfies the request to generate the video that includes the avatar performing the action; and
providing the output video to the messaging application.

11. The method of claim 7, further comprising:
receiving a subsequent prompt that includes a request to generate a subsequent output image of the avatar in one or more pieces of clothing; and
generating, with the selected machine-learning model, the subsequent output image that satisfies the subsequent prompt by illustrating the avatar in the one or more pieces of clothing.

12. The method of claim 7, further comprising:
providing a user interface to the user that includes an icon of the avatar and a text field;
receiving a selection of the icon of the avatar;
displaying the icon of the avatar in the text field;
receiving a subsequent prompt via the text field; and
generating a subsequent output image that satisfies the prompt and that includes the avatar based on the text field including the icon of the avatar in the text field.

13. The method of claim 1, further comprising:
providing subsequent prompts as inputs to the selected machine-learning model one or more times as the user provides subsequent inputs refining the prompt, wherein the subsequent inputs include one or more new words, replacement of words of the prompt, or combinations thereof; and
outputting subsequent output images responsive to receiving the subsequent prompts.

14. The method of claim 1, wherein the set of machine-learning models includes a structure-preserving machine-learning model, a shape-preserving machine-learning model, and a non-structure and non-shape preserving machine-learning model.

15. A system comprising:
one or more processors; and
one or more computer-readable media coupled to the one or more processors, having instructions stored thereon that, when executed by the one or more processors, cause the one or more processors to perform or control performance of operations comprising:
receiving a request for a type of output image and a prompt from a user that describes an output image;
selecting, based on the type of output image and the prompt, a machine-learning model from a set of machine-learning models;
providing the request and the prompt as input to the selected machine-learning model; and
generating, by the selected machine-learning model, the output image that satisfies the request and the prompt.

16. The system of claim 15, wherein the operations further include:
generating a rewritten prompt based on the request for the type of output image and the prompt;
wherein selecting the machine-learning model based on the type of output image and the prompt is further based on the rewritten prompt.

17. The system of claim 15, wherein:
the type of output image includes a sticker;
the selected machine-learning model is trained to output the sticker; and
the output image is the sticker.

18. A non-transitory computer-readable medium with instructions stored thereon that, when executed by one or more computers, cause the one or more computers to perform or control performance of operations, the operations comprising:
receiving a request for a type of output image and a prompt from a user that describes an output image;
selecting, based on the type of output image and the prompt, a machine-learning model from a set of machine-learning models;
providing the request and the prompt as input to the selected machine-learning model; and
generating, by the selected machine-learning model, the output image that satisfies the request and the prompt.

19. The non-transitory computer-readable medium of claim 18, wherein the operations further include:
generating a rewritten prompt based on the request for the type of output image and the prompt;
wherein selecting the machine-learning model based on the type of output image and the prompt is further based on the rewritten prompt.

20. The non-transitory computer-readable medium of claim 18, wherein:
the type of output image includes a sticker;
the selected machine-learning model is trained to output the sticker; and
the output image is the sticker.
